(19) United States
(12) Patent Application Publication
(10) Pub. No.: US 2010/0055448 A1
(43) Pub. Date: Mar. 4, 2010

(54) MULTIPHOTON ABSORPTION FUNCTIONAL MATERIAL, COMPOSITE LAYER HAVING MULTIPHOTON ABSORPTION FUNCTION AND MIXTURE, AND OPTICAL RECORDING MEDIUM, PHOTOELECTRIC CONVERSION ELEMENT, OPTICAL CONTROL ELEMENT, AND OPTICAL MODELING SYSTEM USING THE SAME

(76) Inventors: Tatsuya Tomura, Tokyo (JP); Tsutomu Sato, Kanagawa (JP); Takeshi Miki, Tokyo (JP); Mikiko Takada, Kanagawa (JP)

Correspondence Address: OBLON, SPIVAK, MCCLELLAND MAIER & NEUSTADT, L.L.P., 1940 DUKE STREET, ALEXANDRIA, VA, 22314, US

(21) Appl. No.: 12/514,089

(22) PCT Filed: Nov. 7, 2007
(86) PCT No.: PCT/JP07/72047

§ 371 Date: May 8, 2009

(30) Foreign Application Priority Data
Nov. 8, 2006 (JP) 2006-302772
Nov. 16, 2006 (JP) 2006-310110
Nov. 24, 2006 (JP) 2006-316638

(51) Int. Cl. G02F 1/361; B32B 5/16

(52) U.S. Cl. 428/328; 252/582; 977/773

(57) ABSTRACT

A multiphoton absorption functional material including one of: fine particles of metal, and fine particles partly coated with the metal, the metal generating enhanced surface plasmon field on a metal surface, wherein the fine particles or the fine particles partly coated with the metal are dispersed in a multiphoton absorption material, and wherein the multiphoton absorption functional material is a bulk body.

### TECHNICAL FIELD

The present invention relates to a multiphoton absorption functional material, a composite layer having multiphoton absorption function and a mixture, and an optical recording medium, a photoelectric conversion element, an optical control element and an optical modeling system using the multiphoton absorption functional material, the composite layer having multiphoton absorption function and the mixture.

The present invention also relates to a sensitizing technology of a multiphoton absorbing organic material using localized enhanced plasmon field generated in metal fine particles, and a functional device using the technology.

### BACKGROUND ART

It is known that two-photon absorption, one of the multiphoton absorption processes, can cause reaction only at the focusing point of a focused beam because the reaction is induced by absorption of photons at a probability proportional to the square of excitation light intensity, which is the characteristic feature of the two-photon absorption.

In other words, since it is possible to initiate reactions only at any desired spot in the material and to initiate photoreactions only around the center of the focusing spot of the beam where light intensity is high, expectations have been raised for the achievement of recording that goes beyond the diffraction limit barrier.

However, since the absorption cross section is extremely small in the multiphoton absorption reactions as represented by two-photon absorption reaction, it is an essential condition for excitation to employ an expensive, large pulsed laser source with a notably high peak power, such as femtosecond lasers.

Therefore, it is indispensable to develop a multiphoton absorption material having high sensitivity, which requires no large pulsed laser source and is capable of inducing reactions for instance by semiconductor lasers, in order to accelerate diffusion of applications which make full use of excellent features of the multiphoton absorption reactions.

It is known that several applications characterized by fairly high spatial resolution are attained by using the two-photon absorption phenomenon.

However, conventionally-known two-photon absorption compounds cannot obtain sufficient two-photon absorbing ability, and require a very expensive high-power laser as an excitation light source for exciting two-photon absorption. Therefore, a highly-efficient two-photon absorption material is essential, and development of sensitizing technology is very important for the purpose of practical applications using two-photon absorption by means of a compact and inexpensive laser.

Meanwhile, as a sensitizing method of one-photon absorption process based on optical principle, a method is known in which optical characterization of a trace amount of material is conducted by using an enhanced surface plasmon field being excited on a metal surface.

For example, Patent Literature 1 proposes a technology which applies a plasmon enhancement technology in the course of one-photon transition.

This technology is directed to characterization of optical properties of a slight amount of substance by using a surface plasmon generated in a metal surface. When a surface plasmon microscope is used, for example, a technique has been proposed in which an ultrathin film (note that an enhanced surface plasmon field is generated within a limited region from the surface (approximately 100 nm or less)) disposed over or fixed on the thin metal film deposited on a high-refractive index medium is used as a measurement sample (see Patent Literature 1).

Furthermore, a technique of a measuring method using enhanced surface plasmon field, which is excited by metal fine particles has been conventionally proposed. In this technique, the measurable region is limited within 100 nm or less from the metal fine particles, as similar to the technique disclosed in Patent Literature 1, and observation with a high sensitivity is conducted by observing the sample adsorbed on the surface of the particles.

A technique of tuning resonance wavelength by spherical core-cell structure, as a technique to select the wavelength applicable for observation is also known (see Patent Literature 2).

Further, a highly-sensitive observation method, that is a technology for high-sensitive observation of a sample adsorbed on a fine particle surface, including multiphoton processes using aggregated (metal) nanoparticles arranged (fixed) inside a microcavity is disclosed (see Patent Literature 3).

Additionally, a technology applying localized plasmon generated in metal fine particles is proposed (see Patent Literature 3).

In the meantime, a technique using gold nanorods as a means to generate enhanced surface (localized) plasmon field in place of the above metal fine particles is under research in recent years.

The gold nanorods are materials which are rod-shaped gold nanoparticles, characterized in that resonance wavelength can be changed by changing aspect ratio (a value of long axis-to-short axis ratio) and can cover from approximately 530 nm to infrared (approximately 1,100 nm) region (very unique material capable of absorbing any specific wavelengths from the visible light to near-infrared ray region).

An exemplary manufacturing method of gold nanorods, by which the gold nanorods are manufactured by electric chemical reaction in a solution containing surfactants, is disclosed in Patent Literature 4.

Multiphoton absorbing organic materials will be explained.

Conventionally, various technologies using multiphoton transition have been proposed. The multiphoton transition is a transition in which an atom or a molecule absorbs or releases two or more photons simultaneously, and typical examples of the transition form include a multiphoton absorption in which multiple photons are absorbed simultaneously, a multiphoton release in which multiple photons are released simultaneously, and a raman effect in which one photon is absorbed while another photon is released.

The multiphoton transition is generally a transition caused by high-order perturbation that occurs even in the absence of any energy level at which one photon with the corresponding frequency is absorbed or released, and is observed in high packed photons such as in a laser beam, and its selection rule is different from that for one photon transition.

Particularly, the two-photon absorption phenomenon, in which two photons are involved, is associated with a third-order nonlinear optical effect, and conventionally various studies have been performed.

Meanwhile, it is known that organic materials absorb one photon with energy that is equivalent to its transition energy (excitation energy), so that they generally generate a transition condition (excited condition) which is allowed by a selection principle in one-photon absorption.

However, two photons, each of which has energy equivalent to half the excitation energy, are absorbed simultaneously and transition may occur upon application of a light beam having a high photon density such as a laser beam.

The phenomenon, in which two photons are absorbed simultaneously, offers three-dimensional high resolution and high transmission property to the depth of a substance for the following reasons: (1) transition occurs only near the light focus point having high density of photons, because absorption occurs at a frequency that is proportional to the square of the intensity of incident light; (2) an incident light reaches the depth of a substance without attenuation of light by one-photon absorption, because a photon having half of an energy needed to absorb one photon can excite atoms and molecules. Thus, recently, various applied technologies have been studied for exploiting the above properties, along with technical advances in high-output lasers.

For example, with respect to optical recording media performing recording and reading using light that is vertically incident onto a surface of the optical recording medium while utilizing the above-described three-dimensional high resolution, three-dimensional optical recording media having laminated recording layers have been studied (for example, see Patent Literatures 5 to 10).

These three-dimensional optical recording media are supposed to be capable of super-resolution recording, because changes in spectrum, refractive-index or polarization by means of two-photon absorption are generated only near the light focus point having high photon density to record data.

Conventionally, development relating to application to a photoinduced charge separating element consisting of a pair of a multiphoton absorbing organic material and an electron acceptor, and a photoelectric conversion element using an electrode only modified with a multiphoton absorbing organic material, has been actively advanced. This uses a reaction in which electrons move from a photoinduced molecule to an electron acceptor. It is known that when such a pair is fixed on an electrode surface as a nucleus of photoelectric conversion function, the photoelectric conversion element may possess photoelectric conversion function in the presence of a sacrificial reagent or electron carrier.

Recently, various studies relating to a next-generation dye-sensitized organic solar cell using the multiphoton absorbing organic material have been reported (see Non-Patent Literatures 1 and 2).

Meanwhile, such photocurrent generation is highly emphasized for application to sensors, optical control and the like (see Patent Literatures 11 and 12).

Further, a technology applying to optical modeling has been proposed (see Patent Literature 13).

Next, localized enhanced plasmon will be explained.

Plasmon is a phenomenon that free electrons in a metal are oscillating as a group. In metal fine particles (metal fine particles of the order of nanometers in size, hereinafter referred to as metal nanoparticles in some cases) the plasmon localizes on a particle surface, a phenomenon called localized (surface) plasmon.

In metal nanoparticles, photoelectric field from the visible light to near-infrared ray region efficiently couples to plasmon, and optical absorption occurs. Subsequently, light is converted to localized plasmon, and a significantly locally-enhanced electric field is generated. Namely, optical energy is stored in a metal nanoparticle surface by converting the optical energy to the localized plasmon. Therefore, optical control in a region smaller than optical diffraction limit can be achieved. Moreover, the effect of light scattering caused by the fine particles is relatively small because it is a phenomenon observed in fine particles which are smaller than the wavelength of incident light to the photoelectric field.

The plasmon electric field thus generated can excite the organic material in the metal nanoparticle surface as can light. Therefore, recently, the interaction between metal nanoparticles and light has drawn more attention in photochemical technical fields.

However, the sample of the technique, which is disclosed in Patent Literature 1, is limited to ultrathin film on the thin metal films regarding to the enhancing effect on a thin film, and the applicable region of surface plasmon enhancing effect depends on the forms of the thin metal films and arrangements of the optical systems, and it is difficult to apply in applications such as three-dimensional processes.

Moreover, the technique disclosed in Patent Literature 2 uses enhanced surface plasmon field generated around the particles such as metal fine particles, and the flexibility, in terms of the configuration of the enhanced field generation, is improved over the technique disclosed in Patent Literature 1.

However, the spots for generating enhanced field are also restricted because highly-sensitive reaction and detection are made possible by particles, which generate enhanced surface plasmon field, being distributed on the object surface by the mutual interaction with the object surface. In this technology, the particles, which generate enhanced surface plasmon field, sensitize one-photon absorption reaction, and the applicable range is limited to fine particles. Thus, a selected wavelength range is narrow and the practically applicable range is limited.

The application of enhanced field is also limited for the technique disclosed in Patent Literature 3, because aggregated (metal) nanoparticles, which are means to generate enhanced surface (localized) plasmon field, are arranged within a closed nanospace called microcavity. In the case of localized plasmon, it is also difficult to obtain three-dimensional and uniform enhancement effect, as an enhanced field is limited to a region that is 100 nm or less from a metal fine particle.

As regard to the technique disclosed in Patent Literature 4, flexibility in excitation wavelength selection for the generating means of enhanced surface plasmon field, which is capable of tuning wavelength, is improved; however, a problem still arises in arrangement of excitation sources and reaction materials.

The shift from vacuum tubes to transistors, or advent of all-solid-state elements led to integration and downsizing of electronic devices and made up a foundation of current information society. Similarly, it is considered that the same process, namely all solid state is essential in a plasmonic device, bringing to a facile, short and small element, and improvement of safety and reliability of the element.

When using liquid, homogeneity can be expected from its fluidity, but a circulating system is necessarily used in order to avoid light disturbance and refraction caused by thermal strain.

On the other hand, when a solid material is formed, the density per unit volume is higher than in liquid in which the metal fine particles are relatively dispersed, and then the metal fine particles tend to be aggregated. Thus, a dispersant is very important for forming solid.

When a solid mixture of metal fine particles and a multiphoton absorbing organic material is formed using a dispersant, a dispersant having high affinity for both of the metal fine particles and the multiphoton absorbing organic material is preferably used.

However, when the metal fine particles are coated with a thick dispersant layer, the enhancement effect cannot be effectively obtained because the effect of enhanced plasmon field exponentially decreases according to a distance from a metal fine particle surface. Therefore, it is important to control the distance between the multiphoton absorbing organic material and the metal fine particles, i.e., to make them come close to each other.

Even though the multiphoton absorbing organic material which uses the localized enhanced plasmon field is effectively enhanced and excited by plasmon, an excited condition is quenched due to rapid energy movement from excited molecules to metal fine particles. Therefore, some spacer is needed to be arranged between the metal fine particles and the excited molecules so as to ensure insulation.

Moreover, high efficient multiphoton absorbing organic materials have been proposed, and there is an increasing demand for providing functional devices having superior sensitivity property by use of the multiphoton absorbing organic materials.

Patent Literatures 5 to 10 propose three-dimensional optical recording media which take advantage of excellent characteristics of two-photon absorption.

The respective literatures disclose, as means of recording on or reading from the medium, means utilizing a fluorescence of a fluorescent material, means utilizing a photochromic reaction of a photochromic compound, and means utilizing a refractive index modulation; however, none of the literatures disclose specific examples of two-photon absorption materials, and absorption efficiency is still low, although known two-photon absorption materials are used. Thus a light source with high output power is needed. Moreover, systems using a photochromic reaction as a principle of recording/reading pose practical issues in nondestructive reading, long-term archivability, and S/N ratio in reading, and these systems are not of practical use as optical recording media.

Non-patent Literatures 1, 2 and Patent Literatures 11 and 12 propose various photoelectric conversion devices using excellent characteristics of the multiphoton absorption.

Particularly, a dye-sensitized organic solar battery has an advantage of high efficiency and can be produced at lower costs than a conventional silicon solar battery, thus it is highly expected as a next-generation solar battery.

In order to take out large current from a solar battery, it is important to effectively use sunlight that is a light source having a wide wavelength distribution.

However, a long-wavelength light does not have an energy enough to excite a photosensitizer used in the solar battery, and it does not directly lead to current increase. Therefore, the efficiency of energy conversion is said to be theoretically limited.

On the other hand, it is confirmed that even a long-wavelength light having smaller energy can excite a molecule by using the photosensitizer in the multiphoton absorption material, and thus efficiency of the energy conversion of the solar battery can be increased.

However, efficiency of multiphoton absorption of a conventional multiphoton absorption material is significantly poor, even though a photosensitizer is used in the multiphoton absorption material. Therefore, it has been very difficult to practically obtain satisfactory properties.

Furthermore, conventionally known dye-sensitized organic solar batteries use an electrolytic solution containing an organic solvent which easily vapors into electrolyte, thus problems still remain in leak and long-term stability.

Patent Literature 13 proposes an applied technology relating to optical modeling utilizing excellent property of the multiphoton absorption. However, the efficiency of the multiphoton absorption of the conventional multiphoton absorbing organic material is significantly poor, resulting in failure to obtain practically satisfactory properties.

One of the strategies for improving the efficiency of the multiphoton absorption include a method for increasing the density of molecules.

However, it cannot be expected to significantly improve the properties due to limitation of solubility.

Increasing the density of a particular material may adversely affect components other than the multiphoton absorption material; it causes, for example, decrease of fluorescence intensity due to density quenching in three-dimensional optical recording, and inhibition of curing property of a polymer in optical modeling. Thus, this is not an effective method in terms of practical use.

When the efficiency of the multiphoton absorption cannot be improved due to material property, intensity of incident light may be increased.

However, a laser device with higher output is needed, but the device is difficult to use practically, and material itself may be degraded.

In future years, a technology using three-dimensionally localized enhanced plasmon field generated in metal fine particles is highly demanded, however, Patent Literature 1 and 3 have problems as described above.

Patent Literature 1 Japanese Patent Application Laid-Open (JP-A) No. 2004-156911

Patent Literature 2 JP-A No. 2001-513198

Patent Literature 3 JP-A No. 2004-530867

Patent Literature 4 JP-A No. 2005-68447

Patent Literature 5 JP-A No. 2001-524245

Patent Literature 6 JP-A No. 2000-512061

Patent Literature 7 JP-A No. 2001-522119

Patent Literature 8 JP-A No. 2001-508221

Patent Literature 9 JP-A No. 6-28672

Patent Literature 10 JP-A No. 6-118306

Patent Literature 11 JP-A No. 2001-210857

Patent Literature 12 JP-A No. 8-320422

Patent Literature 13 JP-A No. 2005-134873

Non-Patent Literature 1 M. Lahav, T. Gabriel, A. N. Shipway, I. Willner, J. Am. Chem. Soc., 121, 258 (1999) (three-dimensional nanostructured gold electrode)

Non-Patent Literature 2 Y. Kuwahara, T. Akiyama, S. Yamada, Thin Solid Films, 393, 273 (2001) (dye-sensitized organic solar battery)

### DISCLOSURE OF INVENTION

The present invention has been accomplished in view of the foregoing circumstances, and the object of the present invention is to provide a bulk body of a multiphoton absorption functional material applicable to a wide range, which is used for sensitization of multiphoton absorption reaction using enhanced surface plasmon field, and a composite layer having sensitizing function of multiphoton absorption reaction using enhanced surface plasmon field, and various devices such as an optical recording medium using the multiphoton absorption functional material and composite layer having sensitizing function of multiphoton absorption reaction.

The present invention proposes a technology using three-dimensionally and effectively localized enhanced plasmon field generated in metal fine particles, and an object of the present invention is to provide a mixture which significantly improves efficiency of multiphoton absorption of a multiphoton absorbing organic material, and an optical recording medium, a photoelectric conversion element, an optical control element, and an optical modeling system using the mixture.

These problems are solved by the invention as follows:

<1> A multiphoton absorption functional material including one of: fine particles of metal, and fine particles partly coated with the metal, the metal generating enhanced surface plasmon field on a metal surface, wherein the fine particles or the fine particles partly coated with the metal are dispersed in a multiphoton absorption material, and wherein the multiphoton absorption functional material is a bulk body.
<2> The multiphoton absorption functional material according to <1>, wherein the multiphoton absorption functional material is formed in at least a layer.
<3> The multiphoton absorption functional material according to <2>, wherein the multiphoton absorption functional material is formed in at least two layers, and the layers are separated by an intermediate layer which does not have multiphoton absorption ability.
<4> The multiphoton absorption functional material according to any one of <2> and <3>, wherein each of the at least two layers formed from the multiphoton absorption functional material has substantially the same sensitivity of multiphoton absorption.
<5> The multiphoton absorption functional material according to any one of <2> and <3>, wherein the concentration of the fine particles of metal or the fine particles partly coated with the metal, which metal generates enhanced surface plasmon field, is individually set in each of the at least two layers formed from the multiphoton absorption functional material.
<6> The multiphoton absorption functional material according to any one of <1> and <5>, wherein the fine particles of metal or the fine particles partly coated with the metal are gold nanorods.
<7> The multiphoton absorption functional material according to any one of <1> and <5>, wherein the fine particles of metal or the fine particles partly coated with the metal are aggregated nanoparticles.
<8> A composite layer including: a metal fine particle-containing layer containing fine particles of metal which generates enhanced surface plasmon field on a metal surface, and a multiphoton absorption material-containing layer containing a multiphoton absorption material, wherein the metal fine particle-containing layer and the multiphoton absorption material-containing layer are laminated.
<9> The composite layer according to <8>, wherein the fine particles in the metal fine particle-containing layer aggregate in a boundary between the metal fine particle-containing layer and the multiphoton absorption material-containing layer.
<10> The composite layer according to any one of <8> and <9>, wherein the fine particles are gold nanorods.
<11> The composite layer according to any one of <8> to <10>, wherein the composite layer is a multilayer containing a plurality of laminated bodies which contain the metal fine particle-containing layer and the multiphoton absorption material-containing layer, and each of the plurality of multiphoton absorption material layers has substantially the same sensitivity of multiphoton absorption.
<12> A mixture including: a multiphoton absorbing organic material; fine particles of metal which generates localized enhanced plasmon field; and a dispersant.
<13> The mixture according to <12>, wherein the dispersant comprises a function of suppressing electron movement between the multiphoton absorbing organic material and the fine particles of metal which generates localized enhanced plasmon field.
<14> The mixture according to any one of <12> and <13>, wherein a surface of the fine particles is coated entirely or partly with the dispersant.
<15> The mixture according to any one of <12> to <14>, wherein the dispersant is a silane coupling agent.
<16> The mixture according to any one of <12> to <15>, wherein the mixture is solid at room temperature.
<17> The mixture according to any one of <12> to <16>, wherein the fine particles are nanorods.
<18> An optical recording medium including the mixture according to any one of <12> to <17> as a part of its components, wherein recording and reading is performed by an incident light vertical to a surface of the optical recording medium.
<19> A three-dimensional optical recording medium including the multiphoton absorption functional material according to any one of <1> to <7>, wherein recording and reading can be performed in a traveling direction of an incident light vertical to a layer surface.
<20> A three-dimensional optical recording medium including the composite layer according to any one of <8> to <11>, wherein recording and reading can be performed in a traveling direction of an incident light vertical to a layer surface.
<21> A three-dimensional optical recording medium including the optical recording medium according to <18> having laminated recording layers.
<22> A photoelectric conversion element including the mixture according to any one of <12> to <17> as a part of its components.
<23> An optical control element including the multiphoton absorption functional material according to any one of <1> to <7>.
<24> An optical control element including the composite layer according to any one of <8> to <11>.
<25> An optical control element including the mixture according to any one of <12> to <17> as a part of its components.
<26> An optical modeling system including the multiphoton absorption functional material according to any one of <1> to <7>.
<27> An optical modeling system including the composite layer according to any one of <8> to <11>.
<28> An optical modeling system including the mixture according to any one of <12> to <17> as a part of its components.

According to the present invention, the fine particles of metal or the fine particles partly coated with the metal, which generate enhanced surface plasmon field, are dispersed in the multiphoton absorption material, so as to obtain the effect similar to that using a stronger irradiation light than the one actually used. Thus, remarkable sensitizing effect by multiphoton photoexcitation reaction can be obtained through the material without changing intensity of irradiation light.

The metal fine particles, which generate the enhanced surface plasmon field, are made into nanometer-scale ultrafine particles so as to decrease and avoid loss which may be caused by excitation light scattering.

The mixture of the present invention contains at least a multiphoton absorbing organic material, fine particles of metal which generates localized enhanced plasmon field and a dispersant, wherein the localized enhanced plasmon field generated in the fine particles of metal can be three-dimensionally and effectively used, and efficiency of multiphoton absorption of the multiphoton absorbing organic material can be significantly improved.

By using the mixture of the present invention in various applications, functional elements and functional devices having excellent sensitivity property can be provided.

According to <2> and <3>, the multiphoton absorption functional material is formed as a layer, and a reaction part can be specified in a two-dimensional plane.

Particularly, when this is formed into a multilayer structure, accuracy of specifying a location of a recording part of a three-dimensional periodic structure or the three-dimensional recording is improved, and absorption amount of fine particles which generate enhanced surface plasmon field is easily designed, thereby achieving efficient sensitization.

According to <4> and <5>, in the multilayered material, by setting substantially the same sensitivity of two-photon absorption in each layer, a desired function can be expressed at a desired position in a substance, and a functional material obtaining both advantage of photon absorption reaction and high sensitivity can be obtained.

According to <6>, the multiphoton absorption functional material contains gold nanorods, so as to reproducibly obtain fine particles having a diameter of 20 nm or less and an uniform aspect ratio, and has a wide range of selective wavelengths and high enhancement degree, thereby achieving less scattering loss and efficient sensitization.

Change of the aspect ratio allows to easily cover a range from visible light to near-infrared ray, and then further efficient sensitization at wide ranging absorption wavelengths of multiphoton absorption dye is achieved.

According to <7>, the aggregated nanoparticles are used as fine particles which generate enhanced surface plasmon field so as to promote further reaction of enhanced plasmon field generated in a space between the nanoparticles forming the aggregate, thereby obtaining a functional material having higher sensitivity.

According to any one of <8> to <11>, sensitization of a two-photon absorption compound is achieved and transition efficiency due to photon absorption is improved.

Thus, practical use using a compact and inexpensive laser, such as a three-dimensional memory, optical control element, optical modeling system and the like can be achieved.

Moreover, particularly, when the recording layer (functional layer) is formed into a multilayer such as an application in a three-dimensional multilayer optical memory, a device containing the functional layers having uniform properties can be achieved.

According to <19>, <23> and <26>, reaction can be performed without using an expensive and large pulsed laser, because of a process of high sensitive multiphoton absorption reaction, and the three-dimensional recording medium in which multiple recording can be performed in the traveling direction of the incident light (depth direction) (according to <19>), the optical control element which controls an amount of transmitted light by increasing absorption amount, as irradiation intensity becomes higher (according to <23>), and cost reduction of a microfabricated product of less than diffraction limit and a three-dimensional modeling product (according to <26>), can be achieved by taking advantage of characteristics of multiphoton absorption.

### BRIEF DESCRIPTION OF DRAWINGS

FIG. 1A is a schematic diagram of an example of a recording/reading system of a three-dimensional multilayer optical memory.

FIG. 1B is a cross-sectional schematic diagram showing an example of a three-dimensional optical recording medium.

FIG. 2 is schematic configuration diagram showing an example of a dye-sensitized organic solar battery.

FIG. 3 is a schematic diagram showing an example of an optical control element of the present invention.

FIG. 4 is a schematic diagram showing an example of an apparatus applicable for a two-photon optical modeling method.

FIG. 5 is a schematic configuration diagram showing an example of an optical modeling device.

FIG. 6 is an absorption (resonance) spectrum of aspect ratios of gold nanorods.

FIG. 7 shows an example of a measuring system of two-photon fluorescence.

### BEST MODE FOR CARRYING OUT THE INVENTION

The present invention provides a high sensitive multiphoton absorption functional material, in which fine particles of metal or fine particles partly coated with the metal, which metal generates enhanced surface plasmon field generated on the metal surface, are dispersed in a multiphoton absorption material.

The form of the multiphoton absorption functional material can be selected depending on applications, and examples thereof include a form in which either the fine particles of metal or fine particles partly coated with the metal dispersed in a solvent, a form in which either one is dispersed in a resin and the like as a solid, a form in which either one is dispersed in an uncured resin, and a form in which either one is dispersed in a gel or partly cured resin having high viscosity.

The present invention provides a composite layer, in which a metal fine particle-containing layer containing metal fine particles which generate enhanced surface plasmon field on a metal surface and a multiphoton absorption material-containing layer containing a multiphoton absorption material are laminated, and further provides a three-dimensional optical recording medium, an optical control element and an optical modeling system, which use the composite layer.

The present invention provide a mixture containing at least a multiphoton absorbing organic material, fine particles of metal which generates localized enhanced plasmon field, and a dispersant, and an optical recording medium, a three-dimensional optical recording medium, a photoelectric conversion element, an optical control element and an optical modeling system by using the mixture.

A two-photon absorption material, which is an example of the multiphoton absorption material used in the present invention, can excite molecules at a nonresonant wavelength and in which the actual excited state exists in an energy level approximately double that of the photon used for excitation.

The two-photon absorption phenomenon is a kind of third-order nonlinear optical effect, where a molecule simultaneously absorbs two-photon and transits from a ground state to an excited state. Recently, materials having two-photon absorbing ability have been studied.

However, transition efficiency of the molecule which simultaneously absorbs two-photon in the material having two-photon absorbing ability is inferior to the molecule which absorbs one-photon in the material having one-photon absorbing ability, and transition of the material having two-photon absorbing ability needs a photon having fairly large power density. Thus, transition can be hardly observed at commonly-used laser light intensity levels, but can be observed with an ultrashort pulsed-laser of the order of femtoseconds, such as a mode-locked laser having a high peak light intensity (light intensity in maximum emission wavelength).

The transition efficiency of two-photon absorption is proportional to the square of photoelectric field to be applied (square-law characteristic of two-photon absorption).

Thus, by irradiating with a laser beam, two-photon absorption occurs only in a region of a high electric field intensity in the central position of the laser spot while no two-photon absorption occurs in a region of a low electric field intensity around the central position.

On the other hand, in a three-dimensional space, two-photon absorption occurs only in a region of a high electric field intensity at a focal point obtained by condensing a laser beam through a lens, while no two-photon absorption occurs in other regions out of the focal point because of low electric field intensity. As compared with one-photon linear absorption, in which excitation occurs in all regions at a probability in proportion to the intensity of photoelectric field to be applied, two-photon absorption involves excitation only at one point inside the space due to the square-law characteristic, and thus spatial resolution is remarkably improved.

By taking advantage of these characteristic, a three-dimensional memory, in which spectral variation, refractive-index variation and polarization variation are generated by two-photon absorption to record bit data in a certain position of a recording medium, has been studied. Because the two-photon absorption occurs proportional to the square of light intensity, the pot size in a memory using two-photon absorption can be smaller than that in a memory using one-photon absorption, enabling super-resolution recording. Moreover, applications for an optical control material, curable material of photocurable resin for optical model, and fluorescent dye material for two-photon fluorescence microscope have been developed by virtue of their high spatial resolution based on square-law characteristic.

Moreover, when two-photon absorption is induced, a short pulsed-laser of near-infrared wavelength can be used that has a wavelength longer than the wavelength region where the linear absorption band of a compound is present without inducing absorption. Since a so-called transparent near-infrared light without linear absorption band of a compound is used, the excitation light can reach the interior of a sample without being absorbed or scattered, making it possible to excite the interior of the sample at any desired point with an extremely high spatial resolution by use of the square-law characteristic of two-photon absorption. Thus, two-photon absorption and two-photon emission have been expected for application to photochemical therapies such as two-photon imaging or two-photon photodynamic therapy (PDT) of the body tissue.

Further, since the use of two-photon absorption or two-photon emission allows to withdraw photons having a higher energy than the energy of incident photons, upconversion lasing have been studied from the standpoint of wavelength conversion devices.

Many inorganic materials have been used for two-photon absorption materials. However, there is a problem on the inorganic materials for practical use, because so-called molecular designing for optimizing two-photon absorption property and various physical properties necessary for production of elements is difficult.

While organic materials can optimize a desired two-photon absorption by molecular designing, various physical properties are relatively easily controlled, and are suitable for practical use.

As organic two-photon absorption materials, pigment compounds such as rhodamine, coumarin, dithienothiophene derivatives and oligo(phenylene vinylene) derivatives are known.

However, a two-photon absorption cross section which exhibits two-photon absorbing ability per molecule is small, and particularly, when a femtosecond pulse is used, most of the two-photon absorption cross section are less than 200 (GM: ×10⁻⁵⁰ cm⁴·s·molecule⁻¹·photon⁻¹), and it is not practical for industrial use.

The multiphoton absorption functional material of the present invention will be explained specifically hereinafter.

First, an application of the two-photon absorption material will be explained.

In recent years, networks such as internet and high-vision TVs are rapidly spread.

The capacity of 50 GB or more is preferable even for consumer use in view of high definition television (HDTV) and in particular, demands for large-capacity recording media for easily and inexpensively recording image information of 100 GB or more are increasing.

Moreover, optical recording media which are capable of inexpensively recording large capacity-information of approximately 1 TB or more at high velocities are demanded for industrial use such as computer backups and broadcasting backups.

The capacities of conventional two-dimensional optical recording media such as DVD±R, etc. are approximately 25 GB at most even when the wavelength for recording and reading is shortened, and it is a common concern that the demand for more large capacity hereafter cannot be satisfied sufficiently.

In the situation described above, three-dimensional optical recording media are attracting attention as high-density, large-capacity recording media.

The three-dimensional optical recording medium is configured to dispose tens and hundreds of recording layers in three-dimensional (layer thickness) direction.

Additionally, the three-dimensional optical recording medium may have such a configuration in which several recording layers are disposed on top of each other along the light incident direction as thick layers for recording and reading.

Thus, the three-dimensional optical recording medium achieves ultra-high density, ultra-large capacity recording, which is tens and hundreds times the storage capacity of the conventional two-dimensional recording medium.

It is necessary to be able to randomly access any spot in three-dimensional (layer thickness) direction to write data in the three-dimensional optical recording medium, and the means to do that include a method using a two-photon absorption material and a method using holography (interference).

The three-dimensional optical recording medium using the two-photon absorption material is capable of bit recording at densities several tens to several hundreds times those of conventional ones based on the physical principle and thus is capable of higher density recording; therefore, it is precisely a supreme high-density, large-capacity optical recording medium.

With regard to the three-dimensional optical recording medium using the two-photon absorption material, a method in which fluorescent materials are used for recording and reading, and reading is performed by using fluorescence (see Patent Literatures 5 and 6) and a method in which reading is performed by absorption using photochromic compounds or by using fluorescence (see Patent Literatures 7 and 8) have been proposed.

However, conventionally, in either proposal for the three-dimensional optical recording media, two-photon absorption materials have not been specified or only described abstractly and also, the exemplified two-photon absorption compounds have extremely small efficiency of two-photon absorption. Thus, there have been many problems in practical view.

Moreover, since photochromic compounds used in these techniques are reversible materials which pose practical issues in nondestructive reading, storage property of records in prolonged periods and S/N ratio in reading, these techniques are not of practical use as an optical recording medium.

It is preferable to perform reading by the changes in reflectance (refractive index or absorptance) or emission intensity using reversible materials, particularly in view of nondestructive reading and storage property of records in prolonged periods, however, there are no examples specifically proposing the two-photon absorption materials having above properties.

Furthermore, recording apparatuses which perform recording three-dimensionally by refractive index modulation, reading apparatuses and reading methods are disclosed in Patent Literatures 9 and 10. However, techniques related to methods using the two-photon absorption three-dimensional optical recording materials are not disclosed in these literatures.

As described above, if a reaction is initiated by using excitation energy obtained from nonresonant two-photon absorption to modulate emission intensities between laser focus point (recording) part and non-focus point (unrecorded) part during light irradiation by a non-rewritable method, it is possible to initiate emission intensity modulation in a random spot of three-dimensional space with extremely high spatial resolution, making it applicable for the three-dimensional optical recording medium, which is thought to be an ultimate high density recording medium.

Furthermore, since it is an irreversible material and is capable of nondestructive reading; an appropriate storage property can be expected and is practical for use.

However, the two-photon absorption compounds, which have been assumed to be usable, have a disadvantage of lengthy recording time because two-photon absorbing ability is low and a laser of extremely high power is needed as a beam source. The development of the two-photon absorption three-dimensional optical recording material, which is capable of performing recording with a high sensitivity depending on the difference in emission powers using two-photon absorption, for achieving speedy transfer rate is necessary particularly for the use in the three-dimensional optical recording medium. For that purpose, a material is effective which contains two-photon absorption compounds which can absorb two-photon highly efficiently to generate an excited condition, and recording elements which can make differences in emission powers between two-photon absorption optical recording materials by some kind of method using excited condition of the two-photon absorption compounds. However, such material has not been disclosed before and the development of this kind of material has been desired.

The present invention is to provide a multi(two) photon absorption material, specifically, a multi(two) photon absorption functional material containing a two-photon absorption material, and a two-photon absorption optical recording and reading method, in which recording is performed using two-photon absorption by using the multi(two) photon absorption material of the multi(two) photon compound in an optical recording medium, and then detecting the difference in emission and intensity by irradiating the recording material with a light or detecting the reflectance changes caused by refractive index variation, and a two-photon absorption optical recording (material) medium capable of two-photon absorption optical recording and reading.

The optical recording medium using the multi(two) photon absorption functional material of the present invention can be formed into a basic structure by directly coating on a certain substrate (base material) a multi(two) photon absorption functional material using a spin coater, roll coater or bar coater, or by casting as a layer.

The multiphoton absorption functional material contains a multiphoton absorption material such as a multiphoton absorption dye, and a dispersion of fine particles of metal or fine particles partly coated with the metal, which metal generates enhanced surface plasmon field.

Moreover, according to the present invention, the sensitivity of multi(two) photon absorption material is increased to a practical level by using plasmon enhancement.

In the optical recording medium using the multi(two) photon absorption material of the present invention, the composite layer is formed by coating solutions of the multi(two)-photon absorption material-containing layer and the metal fine particle-containing layer directly on a certain substrate (base material) using a spin coater, roll coater or bar coater, or by casting as a layer.

In the composite layer, the lamination order of the multiphoton absorption material-containing layer and the metal fine particle-containing layer is not specified, and disposing the composite layer at least over or below a certain recording layer satisfies the layer configuration requirement of the present invention.

The above substrate (base material) may be any one of a given natural or synthetic support, and preferably flexible or rigid film, sheet or plate.

Examples thereof include polyethylene terephthalate, resin-subbed polyethylene terephthalate, flame or electro static discharge treated polyethylene terephthalate, cellulose acetate, polycarbonate, polymethylmethacrylate, polyester, polyvinyl alcohol and glass.

In addition, guide grooves for tracking or address information pits may be formed on a substrate in advance depending on a form of a recording medium as a final product.

When the multi(two)photon absorption optical recording material is prepared by a coating method, the used solvent is removed by evaporation during drying.

The evaporation removal of the solvent may be performed by any one of heating and decompressing.

Furthermore, a certain protective layer (intermediate layer) may be formed on the multi(two)photon absorption optical recording material formed by the coating method and casting method as described above to block oxygen or prevent interlayer cross talks.

The protective layer (intermediate layer) may be formed by using polyolefin such as polypropylene and polyethylene, polyvinyl chloride, polyvinylidene chloride, polyvinyl alcohol, polyethylene terephthalate, or plastic films such as cellophane film or, plates may be bonded together using electro-static adherence or lamination layer using extruder, or solutions of above polymers may be applied. It is also possible to form the protective layer (intermediate layer) by bonding glass plates together.

Moreover, it is also possible to provide an adhesive or liquid material between layers for improving airtightness.

Further, certain guide grooves for tracking or address information pits may also be provided on the protective layers (intermediate layers) in advance depending on a form of a recording medium as a final product.

The metal fine particles or rods which generate enhanced plasmon field and which are the constituent feature of the present invention, may be dispersed and mixed in the intermediate layer or in the adhesive layer, or the metal fine particle layer may be formed on a surface of the intermediate layer or the adhesive layer.

Recording and reading are performed by focusing a beam on any layer of the above-mentioned three-dimensional multilayer optical recording medium using the multiphoton absorption functional material of the present invention.

Furthermore, three-dimensional recording can be performed in a traveling direction of incident light (a depth direction) even with a configuration where adjacent recording layers are not separated by protective layers (intermediate layers) by virtue of the characteristic of the multi(two)photon absorption functional material.

The mixture will be explained.

The multiphoton absorbing organic material contained in the mixture of the present invention preferably a pi-conjugated molecule.

Generally, a major factor that is associated with the nonlinearity of a molecule is considered to be due to dominant charge movement in the molecule. This means that a conjugated molecule having a long effective conjugation length easily generates large nonlinear effect, or multiphoton transition.

In a molecular structure, the pi-conjugated molecule is the conjugated molecule having long effective conjugation length, and examples include benzene derivatives, styryl derivatives, stilbene derivatives, porphyrin compound, conjugated ketone derivatives, and conjugate polymers such as polyacetylene and polydiacetylene.

Examples of the fine particles of metal which generates localized enhanced plasmon field include nanometer-scale metal fine particles, certain fine particles which are partly coated with the metal fine particles, and metal fine particles which are partly coated with a certain material.

When these particles are made spherical, production easiness can be achieved.

These fine particles independently couple to light with high efficiency to generate free electron plasma oscillation, and then generate enhanced plasmon field, in which plasma oscillation mode has a specific distribution. It is confirmed that when these fine particles are mutually made close, a very large enhanced plasmon field, which is not merely a sum, is generated between fine particles. A form of a small aggregate or dimer, in which two particles are bonded, are particularly preferred as a form of the fine particles contained in the mixture of the present invention.

The dispersant contained in the mixture of the present invention has a function of suppressing electron movement between the multiphoton absorbing organic material and the fine particles of metal which generates localized enhanced plasmon field.

As described above, even though the multiphoton absorbing organic material, which uses a localized enhanced plasmon field, is effectively enhanced and excited by plasmon, energy rapidly moves from excited molecules to the metal fine particles, and the excited condition is quenched. Therefore, some spacer is necessarily arranged between the fine particles and excited molecules so as to ensure insulation.

In this respect, it is considered that an insulating film is provided as the spacer by coating an oxide film (or an inorganic film such as nitride film) on the metal fine particle surface. When a solid material is formed, a dispersant is needed to be further introduced on the metal fine particle surface. Consequently, reproducibility may be decreased due to a small factor depending on the condition. Thus, an optimal reaction condition is not easily obtained.

On the other hand, a dispersant originally having an insulating function can obtain stable multiphoton absorption property, and examples thereof include silane compounds, organic thiol compounds, and organic amine compounds.

The dispersant preferably entirely or at least partly coats a surface of the fine particle of metal which generates localized enhanced plasmon field.

The fine particles of the metal in which the surface is entirely coated with the dispersant suppress energy movement from an excited molecule to a fine particle of metal, and efficient enhanced plasmon effect can be obtained.

Meanwhile, regarding the fine particles of metal whose surface is partly coated with the dispersant, the present invention is directed to providing a high efficient multiphoton absorption organic material such that it finds application to a functional device such as a photoelectric conversion element. In this case, it is necessary to isolate excited molecules from the metal fine particles and to secure electron conductivity to the metal fine particles, because the metal may possibly function as an electrode as well as a plasmon medium. Therefore, enhanced plasmon effect can be achieved while the energy movement to the metal is suppressed, and electron conduction is effectively generated by adjusting the distance between the excited molecules and the fine particles, and coverage of the dispersant.

The dispersant is preferably a silane coupling agent.

The silane coupling agent has high affinity for the metal fine particles, and exhibits excellent effect as a spacer. Materials used as the silane coupling agent is represented by Structural Formula (1).

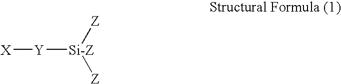

where X represents a reactive group which is chemically bonded with the metal fine particle, and may be a vinyl group, epoxy group, amino group, methacryl group or mercapto group; Z may be a methoxy group or ethoxy group; and Y is generally an atom or atom group having hydrophobicity such as a long-chain alkyl.

Hydrolysis reactions in Z convert the compound to a silanol, leading to a partial oligomer form. Therefore, the dispersant can easily coat the metal fine particle surface.

The localized plasmon electric field exponentially decreases with a distance from the metal fine particle surface. Therefore, the multiphoton absorbing organic material is necessarily made close to the metal fine particles in order to efficiently obtain enhanced plasmon effect.

Examples of the methods for making the multiphoton absorbing organic material close to the metal fine particles include a method for controlling the coverage of the metal fine particle surface by changing the density of the dispersant, and a method for controlling a molecular length of the dispersant.

In order to keep a distance capable of certainly obtaining effect of the localized enhanced plasmon field, a dispersant preferably used is the one capable of controlling the distance from the metal fine particle surface to the multiphoton absorbing organic material to approximately 20 nm, and thereby obtaining an effective enhanced plasmon effect.

However, when the metal fine particles and the multiphoton absorbing organic material are made too close, insulation property may be decreased due to tunnel leak current, bringing to decrease of multiphoton absorption efficiency. When Y is a linear alkyl in Structural Formula (1), Y preferably has 10 to 30 carbon atoms.

The form of the mixture of the present invention may be solid.

Examples of the forms of solid include a thin layer, a thick layer, particles, powders and a bulk body formed from the mixture containing at least the multiphoton absorbing organic material, the fine particles which generate the enhanced plasmon field and the dispersant, and further include solidified mixtures with the addition of acrylic resins such as polymethyl methacrylate, or matrix materials such as polycarbonate, polyester and polyvinyl alcohol.

Particularly, the thin layer is preferable for high performance, or high integrated, downsizing and lightening of device, and geometry effect of the thin layer can be obtained, for example, specific properties such as electrical property, thermal property, quantum effect, superconductive property, magnetic property, optical property, mechanical property, and physicochemical property, therefore new effects can be expected in physical properties and function, and the applicable range to a device is broad.

The fine particles which generate the localized enhanced plasmon field are preferably nanorods.

As used herein, the term “nanorod” means a rod-shaped nanoparticle, and gold and silver are known as metals which can obtain strong resonance by localized plasmon in the visible range.

The advantage of the nanorod is that localized surface plasmon can be excited in a single nanoparticle, and absorption of any specific wavelengths from the visible light to near-infrared ray region can be selected by controlling an aspect ratio (a value of long axis-to-short axis ratio), because the difference in particle diameter is related to the resonance wavelength.

The mixture of the present invention can be used for various functional devices.

For example, the mixture is advantageously used as the optical recording material in the three-dimensional optical recording medium, a photoelectric conversion material in a photoelectric conversion system, and a polymerization initiator or photosensitizer (or a part of it) in a photocurable material of a curable resin for optical modeling.

Hereinafter various application forms will be specifically explained, but the use of the mixture of the present invention will not be limited to the following examples.

### (Three-Dimensional Optical Recording)

In view of the expansion of networks such as the Internet and Intranet, spread of high-vision TVs having image information of 1920×1080 (vertical×horizontal) pixels, and broadcasting high definition television (HDTV), demand for recording media having a storage capacity of 50 GB or more for consumer use, preferably 100 GB or more, for the purpose of archiving data has been increased.

Moreover, optical recording media capable of inexpensively recording large capacity-information of approximately 1 TB or more at high velocities are demanded for computer backups and broadcast image backups.

Three-dimensional optical recording media that are drawing attention as ultimate, high-density, high-storage capacity recording media are recording media capable of recording and reading in vertical and horizontal directions with respect to incident light. In this medium tens and hundreds of recording layers are laminated in three-dimensional (layer thickness) direction, or the recording layer is made thin, whereby multiplex recording is made possible in the light incident direction. Thus, the three-dimensional optical recording medium has a potential of capable of ultra-high density, ultra-large capacity recording, which is tens and hundreds times the storage capacity of the conventional two-dimensional recording medium such as CDs and DVDs.

Next, a preferable embodiment of the three-dimensional multilayer optical memory will be described as an example of the three-dimensional optical recording medium using the multiphoton absorption functional material, the composite layer having multiphoton absorption function, and the solid mixture (multiphoton absorbing organic material) of the present invention as the optical recording material.

The present invention is not limited in scope to these embodiments, and may adopt any other configuration as long as it is capable of performing three-dimensional recording (recording in plane and layer thickness directions).

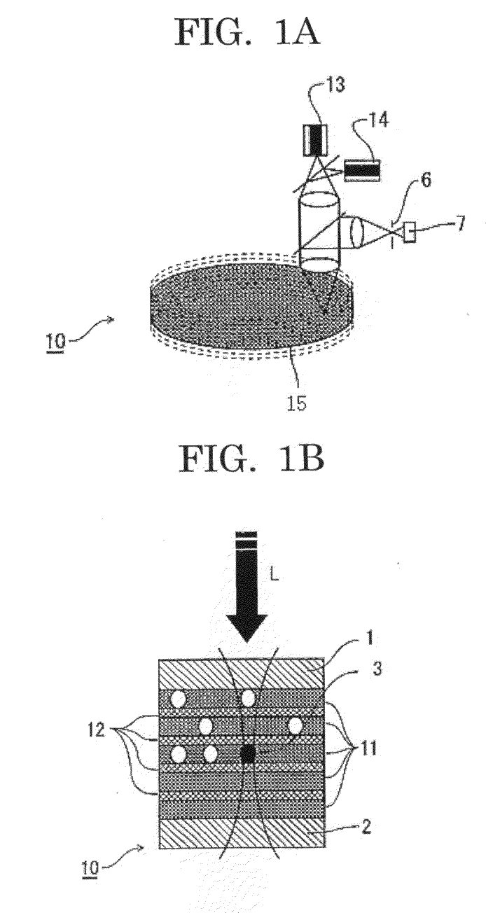

A schematic diagram of recording/reading system of the three-dimensional multilayer optical memory is shown in FIG. 1A and a schematic cross-sectional diagram of the three-dimensional recording medium (recording apparatus) is shown in FIG. 1B.

A three-dimensional optical recording medium 10 as shown in FIGS. 1A and 1B has a multilayered disc structure 15 (with more than 50 layers) in which 50 layers each of a recording layer 11, which uses multi(two) photon absorption compounds (multiphoton absorbing organic material) and an intermediate layer (protective layer) 12 for preventing crosstalks are disposed alternately on a flat support (substrate 1) and each layer is formed by spin coating.

The thickness of the recording layer 11 is preferably 0.01 μm to 0.5 μm and the thickness of the intermediate layer 12 is preferably 0.1 μm to 5 μm.

With the configuration as described above, it is possible to perform ultra high-density optical recording of the order of tera bytes with a disc having the same size as known CDs and DVDs.

Moreover, a substrate 2 (protective layer) identical to the substrate 1 or a reflective layer composed of high-reflectance material is formed on the opposite side across the recording layers 11, in accordance with the reading method of data (transmissive or reflective type).

A recording layer 11 can be formed by directly coating the mixture (multiphoton absorbing organic material) of the present invention on the substrate using a spin coater, roll coater, bar coater or blade coater or by dipping.

The intermediate layer 12 is laminated with the recording layer 11.

By means of a laser beam source for recording 13, a single beam (laser beam L for recording in FIG. 1B) of ultra-short, femtosecond-order pulsed light is used during formation of a recording bit 3.

When information is recorded three-dimensionally, a recording laser beam L is emitted from the recording laser beam source 13 and is focused on a desired point in the recording layer 11. In addition to bit-wise and depth-wise recording, parallel recording using a surface light source is preferably used in order to achieve high transfer rates.

Moreover, high transfer rates can be achieved by producing a bulk three-dimensional optical recording medium without an intermediate layer (not shown) and by batch recording page data as with a hologram recording method.

It is also possible for data reading to use a beam having a different wavelength from the beam used by means of a laser beam source for reading 14, or a beam of the same wavelength with low output power.

The recording/reading system of three-dimensional multilayer optical memory contains a pinhole 6 and a detector 7.

Recording and reading can be performed either on a bit basis or page basis, and parallel recording/reading, which uses surface light sources or two-dimensional detectors, are effective in speeding up of transfer rates.

Meanwhile, examples of the forms of the three-dimensional multilayer optical memory, which is formed similarly in accordance with the present invention, include card-like, plate-like, tape-like and drum-like configurations.

### (Photoelectric Conversion)

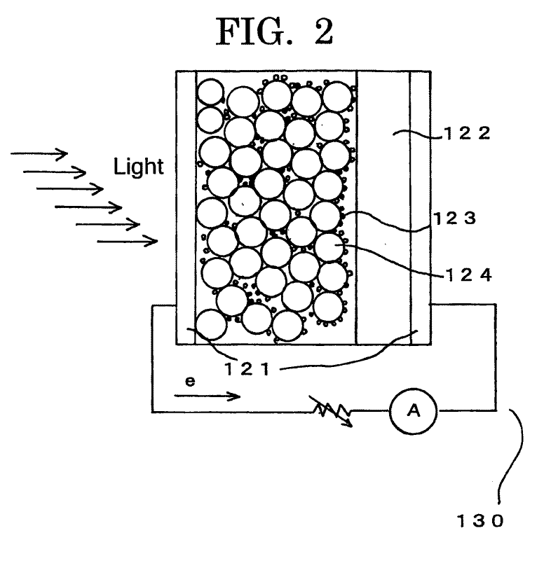

FIG. 2 shows a schematic configuration diagram showing an example of a dye-sensitized organic solar battery 130 using a solid mixture (multiphoton absorbing organic material) of the present invention as an electrode.

FIG. 2 shows a dye-sensitized organic solar battery in which a mixture (multiphoton absorbing organic material) 123 of the present invention and metal fine particles containing a dispersant 124 are put on a light-transmissible transparent conductive film (electrode) 121 and on the opposite electrode side electrolyte 122 is disposed.

Examples of the solid electrolytes 122 include inorganic compounds having hole transfer function such as oxides having oxygen hole in a crystal (stabilized zirconia, CeO₂); organic low molecules, and organic polymer compounds such as ion-conductive polymers (polyethylene oxide). Examples of the transparent conductive films include tin oxides, ITO, and zinc oxides.

The dye-sensitized organic solar battery 130 has electrodes having three-dimensionally expanded area compared to conventional ones, and can effectively use a long-wavelength light having smaller energy, thereby having an advantage of excellent energy taking-out efficiency (energy conversion efficiency) particularly from solar energy. Moreover, it can be, easily produced and can secure long-term stability by solidifying an element.

### (Optical Control Element (Apparatus))

Next, an applications to an optical control element will be explained as an example of specific applications of the multi(two) absorption functional material of the present invention.

In an optical communication and optical information processing, optical control such as modulation, switching and the like is necessary to transmit a signal such as information by light. For this type of optical control, an electric-optical control method using an electric signal has been conventionally adopted. However, the electric-optical control method is limited, for example, band limitation by the time constant of CR such as electrical circuit, limitation of response speed of element itself, or limitation of processing speed due to unbalance of speed between an electrical signal and an optical signal. Thus, an opto-optical control technology is very important which controls an optical signal by an optical signal to take full advantage of merits of light such as broadband property and high speed property. To meet these needs, an optical element is produced by processing the two-photon absorption functional material of the present invention. The optical element allows to modulate light intensity and frequency without using an electronic circuit technology but by using optical change of transmittance, refractive index and absorption coefficient, which are induced by light irradiation, and is applied to an optical switch in an optical communication, optical exchange, optical computer, and optical interconnection.

The optical control element of the present invention which uses change of the optical property by two-photon absorption can provide an optical control element which is very excellent in response speed, compared to an optical control element formed by a common semiconducting material and by one photon excitation. Moreover, an optical control element which is excellent in signal characteristic of high S/N ratio can be provided because of its high sensitivity.

Conventionally, the optical control elements have been disclosed, specifically, those relate to an optical waveguide in which refractive index distribution is formed by focusing on a photorefractive material, in which a refractive index varies, by irradiating with a wavelength light for varying the refractive index.

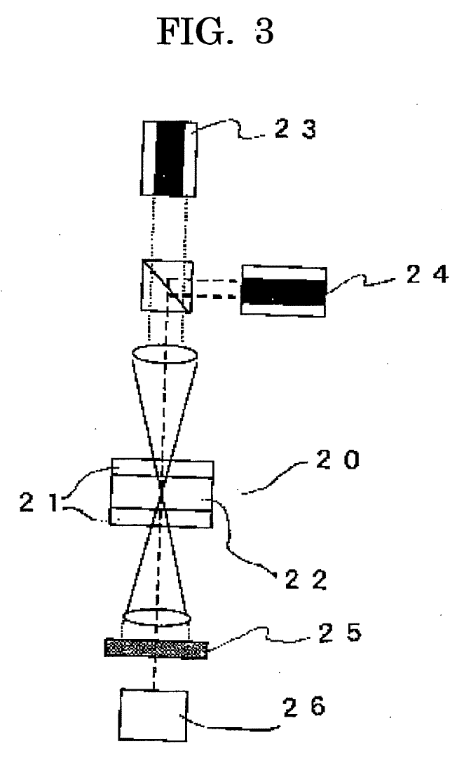

FIG. 3 shows a schematic diagram of an example of an optical control element 20 which optically switches a signal light having one-photon excitation wavelength by subjecting the two-photon absorption functional material of the present invention to two-photon excitation using a control light having two-photon excitation wavelength.

In the example, the optical control element 20 is configured to contain a two-photon absorption material containing metal fine particles or gold nanorods 22 between protective layers 21, but not limited thereto.

The optical control element 20 is subjected to multiphoton excitation by a control light 23 so as to optically switch a signal light 24.

The control light 23 and the signal light 24 have different wavelengths because the control light 23 uses a two-photon process and the signal light 24 uses a one-photon process. Therefore, the control light 23 and the signal light 24 can be separated by a color filter 25.

The separated signal light 24 is detected by a detector 26. This structure allows to obtain both high-speed response of the opto-optical control technique and a high S/N ratio.

With reference to FIG. 3, an example of an optical control device using the mixture of the present invention, or the solid multiphoton absorbing organic material as an optical control material will be described.

An optical control device 20 uses the solid mixture (multiphoton absorbing organic material) of the present invention as the optical control element, and optically switches a signal light 24 by subjecting the optical control element 22 to multiphoton excitation using a control light 23.

Next, an application to a two-photon optical modeling method, which uses the two-photon absorption material as the multiphoton absorption functional material, will be explained.

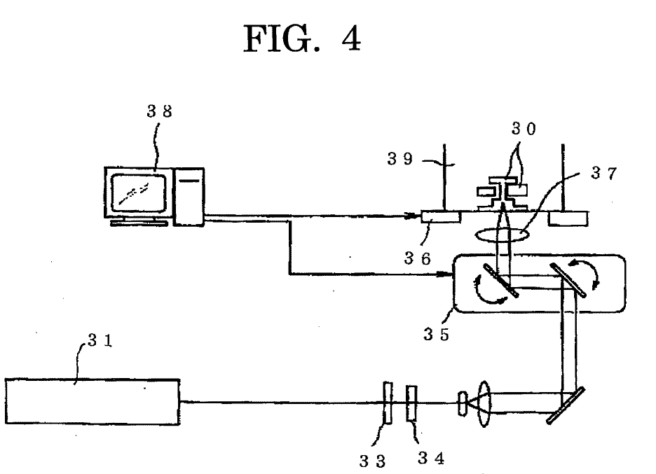

A schematic diagram of an apparatus applicable for a two-photon optical modeling method using the two-photon absorption material is shown in FIG. 4.

In this example, the two-photon micro-optical modeling method for forming any three-dimensional structure, in which method a laser beam from the near-infrared pulsed beam source 31 passes through a shutter 33 which temporally controls amount of transmitted light, an ND filter 34 and a mirror scanner 35 to be focused on a photocurable resin 39 by a lens 37 to move a laser spot, whereby a two-photon absorption is induced to cure the resin only near the light focus point.

In this example, a pulsed laser beam is focused by the lens 37 so as to form a region having high photon density near the light focus point. At this time, the total number of photons, which pass through each cross-section surface of the beam, is constant; therefore, the summation of the light intensity at each cross-section is also constant when a beam is moved two-dimensionally in a focal plane.

However, because the probability of generation two-photon absorption is proportional to the square of the light intensity, a region with a high probability of two-photon absorption is formed only near the light focus point with a high light intensity.

By focusing the pulsed laser beam by the lens 37 to induce two-photon absorption as described above, it becomes possible to cause optical absorption to occur only near the light focus point for pinpoint resin curing.

Since the light focus point can be moved freely in the photocurable resin liquid 39 by means of a Z stage 36 and a galvanometer mirror controlled by a computer 38, it is possible to form a desired three-dimensional article (optically modeled article 30) freely in the photocurable resin liquid 39.

The two-photon optical-modeling method has the following features:

(a) Process resolution exceeding the diffraction limit: this can be realized by nonlinearity of the two-photon absorption against light intensity.

(b) Ultra high-speed modeling: When the two-photon absorption is used, the photocurable resin is not cured in regions other than the light focus point in principle. Therefore, it is possible to speed up the beam scanning speed by increasing the light intensity of irradiation. Therefore, the modeling speed can be increased to approximately ten times as much.

(c) Three-dimensional process: The photocurable resin is transparent to the near-infrared light which induces the two-photon absorption. Therefore, internal curing is possible even when a focused beam is focused deeply into the resin. The problem associated with existing SIH, a difficulty in internal curing due to the decreased light intensity of the focusing point caused by light absorption when a beam is focused deeply, can be overcome with certainty according to the present invention.

(d) High yield: The existing methods have a problem that a modeled article is broken or deformed due to viscosity or surface tension of the resin; however, such problems can be overcome by the method of the present invention because modeling is performed inside the resin.

(e) Application for mass production: It is possible to manufacture a large number of parts or movable mechanisms consecutively in a short period of time by using ultra high-speed modeling.

The photocurable resin 39 for two-photon optical modeling has a characteristic of initiating a two-photon polymerization reaction through light irradiation and altering itself from liquid to solid state.

The main constituents are a resin component composed of an oligomer and reactive diluent and a photo polymerization initiator (and includes a photosensitizing material as necessary).

The oligomer is a polymer with a polymerization degree of approximately 2 to 20, which has many terminal reactive groups.

Moreover, a reactive diluent is added in order to adjust viscosity and curing property.

When a laser beam is irradiated, the polymerization initiator or photosensitizing material exhibits two-photon absorption to generate reactive species directly from the polymerization initiator or through the photosensitizing material, and the polymerization is initialized by reaction with reactive groups of oligomer and reactive diluent.

And then, chain polymerization reactions take place between these reactive groups to form three-dimensional cross-linkages, and it becomes a solid resin having a three-dimensional network in a short period of time.

The photocurable resin is used in fields such as photocurable inks, photo-adhesives, and laminated three-dimensional modeling, and resins having various properties have been developed.

Particularly for the laminated three-dimensional modeling the following properties are important: (1) excellent reactivity; (2) less volume reduction during curing; and (3) excellent mechanical properties after curing.

These properties are also important for the present invention and therefore, the resin, which is developed for the laminated three-dimensional modeling and has a property of two-photon absorption, can be also used as the photocurable resin for the two-photon optical modeling of the present invention.

The specific examples, which are often used, include photocurable acrylate resins and photocurable epoxy resins, and photocurable urethane acrylate resins are particularly preferable.

A technique related to optical modeling known in the art is disclosed in JP-A No. 2005-134873.

This is a technique in which an interference exposure of the surface of a photosensitive polymer layer is performed by means of a pulsed laser beam without a mask.

It is important to use a pulsed laser beam of a wavelength region in which photosensitive function of the photosensitive polymer layers can be brought out.

Thereby, it is possible to appropriately select the wavelength region of the pulsed laser beam depending on the types of photosensitive polymers or on the types of the groups or sites of the photosensitive polymers by which photosensitive function is brought out.

In particular, it is possible to bring out the photosensitive function of the photosensitive polymer layers by going through a multilayer absorption process at the time of irradiating a pulsed laser beam, even when the wavelength of the pulsed laser beam emitted from the light source does not fall within the wavelength region in which the photosensitive function of the photosensitive polymer layers can be brought out.

Specifically, if a focused pulsed laser beam is applied from a light source, absorption of multiphoton (absorption of two photons, three photons, four photons, or five-photons, etc.) takes place and the photosensitive polymer layers is essentially irradiated with the pulsed laser beam of a wavelength region where a photosensitive function of the photosensitive polymer layers is brought out, even though the wavelength of the pulsed laser beam irradiated from the light source may not fall within a wavelength region where the photosensitive function of the photosensitive polymer layers can be brought out.

As described above, the pulsed laser beam for interference exposure may be a pulsed laser beam of the wavelength region where the photosensitive function of the photosensitive polymer layers can be practically brought out and the wavelength may be appropriately selected depending on irradiation condition.

For example, it becomes possible to obtain an ultraprecise three-dimensional modeled article by adopting a photosensitizing material as a two-photon absorption material of the present invention, dispersing the material in an ultraviolet curable resin to produce a photosensitive solid, and curing the photosensitive solid only at portions where the focused spot applies by using two-photon absorbing ability of the photosensitive solid.

The two-photon absorption material of the present invention may be used as a two-photon absorption polymerization initiator or a two-photon absorption photosensitizing material.

Since the two-photon absorption material of the present invention has a higher two-photon absorption sensitivity than the conventional two-photon absorption functional material (two-photon absorption polymerization initiator or two-photon absorption photosensitizing material), the two-photon absorption material of the present invention cam be modeled at high speed and can utilize a small-sized and inexpensive laser beam source as an excitation light source, making it to be applicable to practical applications capable of mass production.

### (Optical Modeling Device)

FIG. 5 is a schematic configuration diagram showing an example of an optical modeling device 50 which uses the mixture (multiphoton absorbing organic material) of the present invention as a polymerization initiator or photosensitizer (or a part of it) in a photocurable material.

A light beam from a light source 41 is condensed on a photocurable material 44 containing the mixture (multiphoton absorbing organic material of the present invention via a movable mirror 42 and a condensing lens 43, and then an area having a high density of photons is formed only near the light focus point, thereby curing the photocurable material 44. Any three-dimensional structure can be modeled by controlling the movable mirror 42 and movable stage 45.

As used herein, the term “photocurable material” is a material in which multiphoton polymerization reactions occur by light irradiation and the material changes its state from liquid to solid.

The photocurable material mainly contains a resin component consisting of an oligomer and a reactive diluent, and a photopolymerization initiator, and may further contain a photosensitizer as additional components.

The oligomer is a polymer having a degree of polymerization of approximately 2 to 20 and many reactive groups at its terminals, and generally a reactive diluent for adjusting viscosity and curing degree is added.

By light irradiation, the polymerization initiator (or photosensitizer) absorbs multiphoton, and a reactive species is generated directly from the polymerization initiator (or through a photosensitizing material) to initiate polymerization, and then three-dimensional crosslinking is formed via chain polymerization reaction, thereby changed to a solid resin having a three-dimensional network structure in a short time.

It is confirmed that use of the mixture (multiphoton absorbing organic material) of the present invention as the polymerization initiator or photosensitizer (or a part of it) in the photocurable material allows an ultraprecise three-dimensional modeling of excellent in reactivity and production stability and exceeding the diffraction limit.

By using the mixture (solid multiphoton absorbing organic material) of the present invention, the localized enhanced plasmon field which is generated in the metal fine particles can be three-dimensionally and effectively used, and accordingly a functional material and functional device at practical level, which do not need a light source with high cost and high output, can be provided.

Next, control of absorption sensitivity of the multi(two)photon absorption functional material of the present invention will be explained.

The multi(two) photon absorption functional material of the present invention is a mixed material of fine particles which generate enhanced surface plasmon field, and a multiphoton absorption material.

Therefore, it is considered that the sensitivity of effective multiphoton absorption reaction is generally proportional to the amount of beam consumed by a multiphoton absorption reaction excited by excitation light, and thus the sensitivity of effective multiphoton absorption reaction is given as a product of the sensitivity of a multiphoton absorption material alone and the sensitivity of fine particles which generate enhanced surface plasmon field.

Improved sensitivity of multiphoton absorption reaction can be achieved either by increasing the multiphoton absorption sensitivity of the multiphoton absorption material or by increasing the dispersion concentration of the multiphoton absorption material.

For the purpose of sensitization of fine particles which generate enhanced surface plasmon-field, particles which can obtain larger enhancing effect of enhanced plasmon field by changing the shape of fine particles are selected, or dispersion concentration of particles which generate enhanced surface plasmon field is increased.

However, since the fine particles generate enhanced surface plasmon field by one-photon absorption, it is important to design the concentration distribution of fine particles in the depth direction in order not to decrease sensitivity in deeper parts (i.e., in order not to decrease transmittance of excitation light).

Therefore, in order to obtain a uniform sensitivity distribution in the depth direction, it is necessary to determine the distribution in the depth direction of each of the parameters that determine the above-described sensitivity of the effective multiphoton absorption reaction while considering the balance between the amount of transmitted excitation light per each depth and these parameters. These parameters can be changed for each layer, in case of a multilayer structure.

To “obtain uniform sensitivity” means that the structure has a sensitivity of substantially the same; specifically, the uniform (same) sensitivity is ±10% of light irradiation power, preferably within ±5% of light irradiation power.

Next, fine particles which generate enhanced surface plasmon field will be explained.

The surface plasmon is localized plasmon generated near fine particles.

The localized plasmon generated near fine particles is characterized in that coupling with an excitation light (diffusion light) easily occurs (needs no special optical arrangement), and the effect of scattering caused by the fine particles is relatively small because it is a phenomenon observed in fine particles that are smaller than the wavelength of light, allowing to avoid scattering loss.

The plasmon absorption of the fine particles is so strong that dispersing a ultra trace amount of particles for absorption of photons causes color development to a level that allow them to be used as a coloring material. For example, gold fine particles dispersed in glass has been known as particles contained in transparent, red stained glass used for glass technology from long ago. Specifically, the plasmon absorption of the fine particles can balance one-photon absorption of particles which generate enhanced surface plasmon field dispersed in a bulk body, intensity of absorbed optical energy and loss caused by scatter, and then excite multiphoton absorption in a depth of the bulk body.

One-photon absorption occurs on fine particles which generate enhanced surface plasmon field by an excitation light and induces free electron plasma oscillation in the fine particles, and then localized enhanced plasmon field, in which plasma oscillation mode has a specific distribution, is generated.

In a case of metal fine particles, the most easily available particles are spherical fine particles.

The spherical gold fine particles exhibit the strongest absorption at a light wavelength of approximately 520 nm.

It has been confirmed that in rod-shaped gold fine particles (so-called gold nanorods), of which a reproducibly-obtainable synthesis method has been developed, as the ratio of length to width increases, or the gold nanorods become thinner, strong absorptions are generated at longer wavelengths due to resonances in the length direction, and that they produced an enhanced plasmon field that is many orders of magnitude higher in intensity than that produced by the spherical gold fine particles. The gold nanorods are used as a source for generating localized enhanced plasmon field, thereby obtaining higher sensitization of multiphoton absorption.

The fine particles, which generate enhanced surface plasmon field, generate their own localized enhanced plasmon field with an excitation light. When the particles come close, not only their enhanced fields overlaps, but also a larger localized enhanced plasmon field is generated in a space between them.

Examples of the structures which generate such a large enhanced plasmon field include (1) fine particle surface (partly) coated with a metal which generates enhanced surface plasmon field, and (2) particles adsorbing thereon fine particles of the metal which generates enhanced surface plasmon field. As used herein, the phrase “fine particles of metal which generates enhanced surface plasmon field, or fine particles partly covered with the metal” includes both the above (1) and (2) in a broad sense.

Moreover, a method using aggregates formed from the metal fine particles which generate enhanced surface plasmon field, are also used.

In the present invention, it is found that in a small aggregate such as a substantially dimer form in which two particles are bonded, effect of loss by scattering is relatively small, and large enhancing effect and sensitizing effect of the multiphoton absorption can be obtained in a bulk body.

The small aggregate can be reproduced by optimizing a balance between a viscosity of a raw material solution and a cohesion force.

According to the two-photon absorption sensitization system of the present invention, since the two-photon absorption material of the present invention has a higher two-photon absorption sensitivity than the conventional two-photon absorption functional material (two-photon absorption polymerization initiator or two-photon absorption photosensitizing material), the two-photon absorption system of the present invention can provide high-speed shaping and can utilize a small-sized and inexpensive laser beam source as an excitation light source, making it applicable to practical applications capable of mass production.

Next, the composite layer of the present invention containing metal fine particles which generate enhanced surface plasmon field on a metal surface, and gold nanorods making up the metal fine particles will be explained.

It is known that a resonant absorption phenomenon called plasmon absorption occurs when the metal fine particles are irradiated with light. For example, a gold colloid, in which spherical metal fine particles are dispersed in water, has a single absorption band at a wavelength of approximately 530 nm, and exhibits bright red color. These spherical metal fine particles are used in stained glasses and the like as a red colorant.

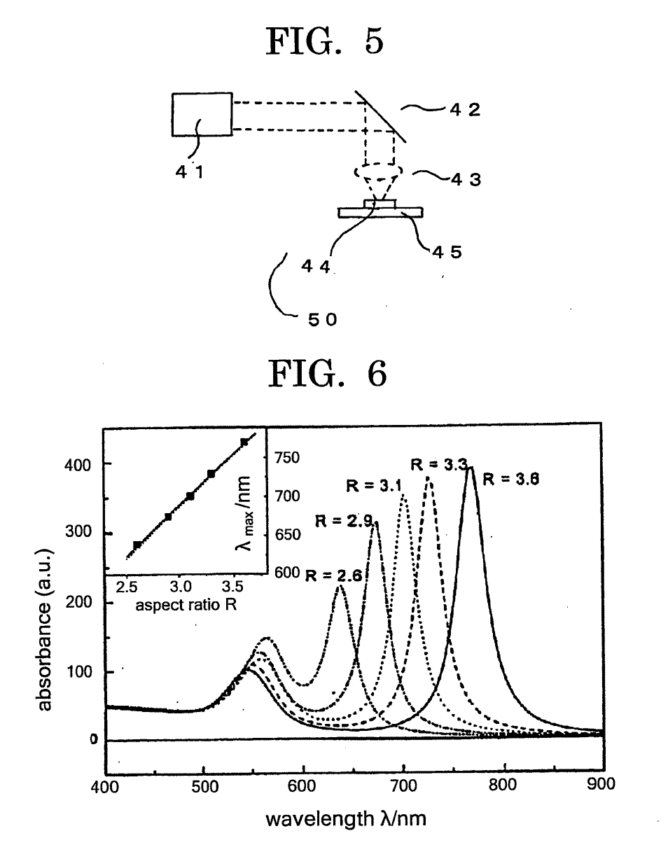

On the other hand, gold nanorods which are one kind of the metal fine particles, are rod-shaped gold fine particles, and attract attention as a very unique material capable of absorbing any specific wavelengths from the visible light to near-infrared ray region by controlling an aspect ratio (a value of long axis/short axis: R). As the aspect ratio is larger, the absorption (resonance) wavelength shifts to longer wavelengths. The absorption (resonance) spectrum of the aspect ratios is shown in FIG. 6.

The gold nanorods are excellent in wavelength selectivity. Specifically, the material can improve further sensitization efficiency by matching their absorption (resonance) wavelength to the wavelength used in an optical device.

The fine particles, which generate enhanced surface plasmon field, generate their own enhanced plasmon field with an excitation light. When the particles come close, not only the enhanced fields overlaps, but also a larger enhanced plasmon field is generated in a space between them. The large enhanced plasmon field is notably generated in a substantially dimer form or an aggregate of fine particles.

Particularly, it has been confirmed that making the particles to be small aggregates containing a substantially dimer form leads to reduced loss of light use efficiency caused by light scattering, and to a function of an enhance layer capable of obtaining larger enhancing effect.

The gold nanorods as described above can control resonance (absorption wavelength) by the aspect ratio, for example, a wavelength light of 780 nm is used to be applied to an optical device, the gold nanorods having an aspect ratio of approximately 3.5 theoretically obtains best sensitization efficiency as shown in FIG. 6. The present invention takes advantage of two-photon absorption, a transmission property for a light to be used, and excessively large amount of absorption may cancel two-photon property depending on conditions. When the transmission of light to be used is considered important, the light absorption amount of gold nanorods for the light is less than 5%, and preferably 1% or less. When it is not so important, the light absorption amount of gold nanorods for the light is 30% or less, and preferably 20% or less.

Next, a metal fine particle-containing layer and a multiphoton absorption material-containing layer which constitute the composite layer of the present invention will be specifically explained.

The multi(two) photon absorption material-containing layer may be formed in a thin film, or a bulk of two-photon absorption materials or two-photon absorption materials dispersed and mixed in a resin. Particularly, in case of application to an optical modeling, two-photon absorption materials are needed to be dispersed in a photocurable resin such as an ultraviolet curable resin, and a layer thickness may not particularly limited and depend on a desired modeled article. Then the photocurable resin has a high fluidity, the metal fine particle-containing layer and the two-photon absorption layer are disposed in a cavity, and an unexposed portion is washed away after light irradiation so as to establish an optical modeling method capable of increasing sensitivity. In case of application to an optical control element, the layer thickness may not be strictly limited. On the other hand, in case of application to a three-dimensional multilayer memory, the layer thickness is as described above.

Next, the metal fine particle-containing layer containing metal fine particles, such as the gold nanorods will be explained.

For example, gold or silver is dispersed in an aqueous solvent in a specific condition to obtain a colloidal dispersion as spherical fine particles, and a mixture with spherical fine particles having shape anisotropy.

Particularly, gold can be used to obtain a colloidal dispersion containing gold nanorods dominating in fine particles, and a mixture of nanorods and spherical fine particles.

A layer which enhances two-photon absorption property, specifically, the metal fine particle-containing layer which constitutes the composite layer of the present invention, may be formed in a single layer in which metal fine particles (for example, gold nanorods) are two-dimensionally placed on over a surface, may be a layer having aggregates in some areas, a bulk layer in which many layers containing fine particles are laminated, and a layer in which the metal fine particles are dispersed and mixed in a binder such as a resin. The metal fine particle-containing layer has a thickness of approximately 10 nm to 500 μm.

As to a sensitization effect, it is confirmed that the high sensitization efficiency can be obtained by selecting the single layer in which metal fine particles (for example, gold nanorods) are two-dimensionally placed over a surface in the form of individual particle, the layer having aggregates in some regions, particularly aggregates localized at a boundary with the two photon absorption material-containing layer, and it is a preferred embodiment.

This preference contradicts the fact that the metal fine particles and gold nanorods show absorption at a laser wavelength to be used, and that metal fine particles showing two-photon absorption are utilized that have high transparency to a laser due to the effect of light scattering caused by the metal fine particles. Therefore, high-efficient sensitization is preferably obtained by selecting a structure, concentration and distribution, which decrease the effect of absorption or scattering of light by the metal fine particles and gold nanorods as much as possible at a wavelength to be used. The sensitization is preferably achieved by a single metal fine particle-containing layer on a surface or the metal fine particle-containing layer which is less affected by light scatter from fine particles or nanorods localized at a boundary with a photosensitive layer. The structure of localized fine particles and nanorods enable to obtain sensitization by localized plasmon resonance between particles, and contributing to high-efficient sensitization.

Next, a structure for uniform sensitivity, in which the composite layer of the present invention contains a repeated laminated structure, will be explained.

When the metal fine particle-containing layer and the two photon absorption material-containing layer are repeatedly laminated several times so as to be a multiple layer, light use efficiency generally decreases as an incident light travels toward the depth.

Consequently, each two-photon absorption layer is desired to have uniform sensitivity. Examples of methods for obtaining uniform sensitivity include a method for increasing sensitivity of the two photon absorption material-containing layer toward deeper in the layer, and a method for decreasing two-photon absorbing ability toward the light incident direction of the two-photon-absorption material layer, specifically, a method for distributing a two-photon absorption material having higher sensitivity toward deeper in the layer. Additionally, each two-photon absorption layer can also have uniform sensitivity by the method for decreasing two-photon absorbing ability toward the light incident direction of the two-photon absorption material layer, in which the two-photon absorption layer is diluted with a binder and the like so as to gradually decrease two-photon absorbing ability toward the light incident.

Each layer can have uniform sensitivity by adopting the same two-photon absorption materials (layers) or by setting an appropriate distribution amount of metal fine particles (nanorods) which constitute the sensitizing material of the present invention. Specifically, each of the two-photon absorption layers can have uniform sensitivity of two-photon by decreasing the distribution concentration of the metal fine particles (nanorods) contacting the two-photon absorption layer which is disposed toward the light incident direction, and increasing the distribution concentration of the metal fine particles (nanorods) toward deeper in the layer.

Here, “substantially the same sensitivity” means that a uniform (same) sensitivity is ±10% of light irradiation power, preferably within ±5% of light irradiation power.

As described above, according to the invention, sensitization of the multi(two) photon absorption compound can be achieved and transition efficiency of photon absorption is improved. Specifically, practical applications by using a compact and inexpensive laser, such as a three-dimensional memory, optical control element, optical modeling system and the like, can be achieved.

Moreover, a device having functional layers, in which the properties are uniformed, can be achieved, particularly, by a multilayered recording layer (functional layer), such as an application in a three-dimensional multilayer optical memory.

### EXAMPLES

Hereinafter, with referring to Examples and Comparative Examples, the invention is explained in detail by preparing specific samples, and the following Examples and Comparative Examples should not be construed as limiting the scope of the invention.

### Example A-1

Ten grams of silver nitrate and 37.1 g of oleylamine (85%) were added in 300 ml of toluene, and stirred for 1 hour. Then, 15.6 g of ascorbic acid was added and stirred for 3 hours. Subsequently, 300 ml of acetone was added, a supernatant was removed by decantation and a solvent contained in a precipitate was distilled off to obtain spherical silver fine particles having a diameter of 10 nm to 30 nm.

One milligram of the obtained spherical silver fine particles were redispersed in 10 ml of toluene, and then 7 mg of a two-photon fluorescent dye represented by Formula (1) was added and stirred.

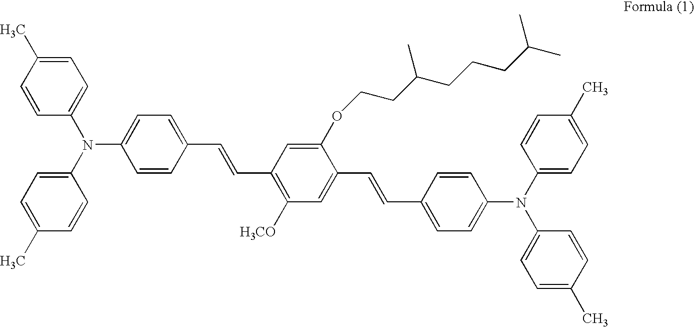

After the dye was dissolved, 1 g of acrylic resin DIANAL BR-75 (from MITSUBISHI RAYON CO., LTD.) was further added and stirred to be melted. The obtained solution was poured in a frame formed on a glass substrate. The solvent was vaporized for solidification, thereby yielded a bulk body consisting of spherical silver fine particles and two-photon fluorescent dye dispersed acrylic resin and having a thickness of 50 μm.

### Example A-2

One milligram of the spherical silver fine particles obtained in Example A-1 was redispersed in 10 ml of toluene, and mixed with 0.2 g of 1 mass % polyethylenimine (from NIPPON SHOKUBAI CO., LTD., average molecular mass of 300) in a toluene solution, and a small aggregate of spherical silver fine particles was confirmed by a color change of the dispersion.

Additionally, 7 mg of the two-photon fluorescent dye represented by Formula (1) was added and stirred to be dissolved in the solution, and then 1 g of acrylic resin DIANAL BR-75 (from MITSUBISHI RAYON CO., LTD.) was added and stirred to be melted. The obtained solution was poured in a frame formed on a glass substrate. The solvent was vaporized for solidification, thereby yielded a bulk body consisting of aggregated spherical silver fine particles and two-photon fluorescent dye dispersed acrylic resin, and having a thickness of 50 μm.

### Example A-3

Chloroauric acid (0.37 g) was added in 30 ml of water, and then a mixed solution of 2.187 g of tetraoctylammonium bromide and 80 ml of toluene were added and stirred for 2 hours.

Additionally, 0.2 g of 1-dodecanethiol was added and stirred for 1 hour.

Subsequently, a solution of 0.378 g of NaBH₄ dissolved in 20 ml of water was added dropwise and stirred for 2 hours.

The reaction product was washed with water using a separating funnel for several times, and then a solvent of an organic layer was distilled away to obtain spherical gold fine particles having a diameter of 20 nm to 50 nm.

Three milligrams of the obtained spherical gold fine particles were redispersed in 10 ml of toluene, and then 7 mg of the two-photon fluorescent dye represented by Formula (1) was added and stirred to be dissolved in the solution, and then 1 g of acrylic resin DIANAL BR-75 (from MITSUBISHI RAYON CO., LTD.) was further added and stirred to be melted. The obtained solution was poured in a frame formed on a glass substrate. The solvent was vaporized for solidification, thereby yielded a bulk body consisting of spherical gold fine particles and two-photon fluorescent dye dispersed acrylic resin, and having a thickness of 50 μm.

### Example A-4

Three milligrams of the spherical gold fine particles obtained in Example A-3 was redispersed in 10 ml of toluene, and mixed with 0.2 g of 1 mass % polyethylenimine (from NIPPON SHOKUBAI CO., LTD., average molecular mass of 300) in a toluene solution, and then dispersed. The presence of a small aggregate of spherical gold fine particles was confirmed by a color change of the dispersion.

Additionally, 7 mg of the two-photon fluorescent dye represented by Formula (1) was added and stirred to be dissolved in the solution, and then 1 g of acrylic resin DIANAL BR-75 (from MITSUBISHI RAYON CO., LTD.) was added and stirred to be melted. The obtained solution was poured in a frame formed on a glass substrate. The solvent was vaporized for solidification, thereby yielded a bulk body consisting of aggregated spherical gold fine particles and two-photon fluorescent dye dispersed acrylic resin, and having a thickness of 50 μm.

### Example A-5

Seventy milliliters aqueous solution of 0.18 mol/l cetyltrimethylammonium bromide, 0.36 ml of cyclohexane, 1 ml of acetone, and 1.3 ml aqueous solution of 0.1 mol/l silver nitrate were mixed and stirred. Subsequently, 0.3 ml aqueous solution of 0.24 mol/l chloroauric acid was added, and 0.3 ml aqueous solution of 0.1 mol/l ascorbic acid was further added so as to erase the color of the chloroauric acid solution, and the color erase was confirmed. This solution was poured into a dish and irradiated with an ultraviolet ray having a wavelength of 254 nm for 20 minutes using a low-pressure mercury lamp to obtain a gold nanorod dispersion having an absorption wavelength of approximately 830 nm.

In this dispersion, the gold nanorod component was settled by centrifugation. The process of removing the supernatant from the dispersion, adding water and then centrifuging the dispersion was repeated several times to remove excess cetyltrimethylammonium bromide as a dispersant. One gram of the gold nanorod dispersion was mixed with 0.4 g of 1 mass % polyethylenimine (from Wako Pure Chemical Industries, Ltd., average molecular mass of 1,800) in an acetone solution. Two grams of DMF solution containing 5 mass % acrylic resin DIANAL BR-75 (from MITSUBISHI RAYON CO., LTD.) was further added. And then, 0.7 mg of the two-photon fluorescent dye represented by Formula (1) was added and stirred, subsequently concentrated to a several ml by decompression. The obtained solution was poured in a frame formed on a glass substrate. The solvent was vaporized for solidification, thereby yielded a bulk body consisting of gold nanorods and two-photon fluorescent dye dispersed acrylic resin, and having a thickness of 50 μm.

### Example A-6

One gram of the gold nanorod dispersion obtained in Example A-5 was mixed with 0.4 g of 1 mass % polyethylenimine (from Wako Pure Chemical Industries, Ltd., average molecular mass of 1,800) in an acetone solution, and then 10 g of DMF solution containing 10 mass % acrylic resin DIANAL BR-75 (from MITSUBISHI RAYON CO., LTD.) was mixed. Two hundred grams of photochromic dye (from TOKYO CHEMICAL INDUSTRY CO., LTD., B1536) was further added and stirred, subsequently concentrated to 10 ml by decompression. The obtained solution was poured in a frame formed on a glass substrate in several times and the solvent was vaporized for solidification, thereby yielded a bulk body consisting of gold nanorods and photochromic dye dispersed acrylic resin, and having a thickness of 500 μm.

### Example A-7

One gram of the gold nanorod dispersion obtained in Example A-5 was mixed with 0.4 g of 1 mass % polyethylenimine (from Wako Pure Chemical Industries, Ltd., average molecular mass of 1,800) in an acetone solution, and then 1 g of DMF solution containing 1 mass % acrylic resin DIANAL BR-75 (from MITSUBISHI RAYON CO., LTD.) was mixed. Two milligrams of photochromic dye (from TOKYO CHEMICAL INDUSTRY CO., LTD. B1536) was further added and stirred, subsequently concentrated to a several ml by decompression. The mixed solution was coated on a glass substrate to form a layer having a thickness of 0.5 μm by spin coating. The layer had one-photon absorptance of approximately 11.4% at an excited light wavelength, and 5 mass % PVA aqueous solution was coated thereon to form a layer having a thickness of 5 μm by spin coating. Next, a part of the mixed solution was taken to alternately dispose a spin-coated layer formed from the mixed solution of the dye and binder resin (1 μm-thick) and, in which dye concentration was the same as that in the 0.5 μm-thick layer and one-photon absorptance was as described below, and a spin-coated layer formed from a mixed solution of the mixed solution and the PVA aqueous solution (5 μm-thick) respectively by means of spin coating, so as to alternately dispose five layers of gold nanorods and photochromic dye dispersed acrylic resin and PVA layers. And then, a layer containing fine particles which generate localized enhanced plasmon field and two-photon absorption dye, and having a modulated concentration, and a separation layer were alternately disposed to form a laminated structure.

### <One-Photon Absorptance in Each Layer>

First layer (surface side): 5.0%

Second layer: 5.8%

Third layer: 7.0%

Fourth layer: 8.7%

Fifth layer (undermost layer): 11.4%

### Comparative Example A-1

Seven milligrams of the two-photon fluorescent dye represented by Formula (1) was added in 10 ml of toluene and stirred to be dissolved. One gram of acrylic resin DIANAL BR-75 (from MITSUBISHI RAYON CO., LTD.) was further added and stirred to be melted. The obtained solution was poured in a frame formed on a glass substrate. The solvent was vaporized for solidification, thereby yielded a bulk body of two-photon fluorescent dye dispersed acrylic resin having a thickness of 50 μm.

### Comparative Example A-2

Two hundred milligrams of photochromic dye (from TOKYO CHEMICAL INDUSTRY CO., LTD., B1536) was added in 10 g of DMF solution containing 10 mass % acrylic resin DIANAL BR-75 (from MITSUBISHI RAYON CO., LTD.) and stirred. The obtained solution was poured in a frame formed on a glass substrate in several times and the solvent was repeatedly vaporized to be solidified, thereby yielded a bulk body of photochromic dye dispersed acrylic resin having a thickness of 500 μm.

### Comparative Example A-3

The mixed solution of gold nanorods and photochromic dye used for the fifth layer (undermost layer) in Example A-7 was coated on a glass substrate to form a layer having a thickness of 0.5 μm by spin coating.

On the spin-coated layer, 5 mass % PVA aqueous solution was coated to form a layer having a thickness of 5 μm by spin coating, and next the mixed solution and the PVA aqueous solution was alternately coated so as to alternately dispose five layers of gold nanorods and photochromic dye dispersed acrylic resin and PVA layers. And then, a layer containing fine particles which generate localized enhanced plasmon field and two-photon absorption dye, and having a uniform concentration and a separation layer were alternately disposed to form a laminated structure.

### <First Evaluation: Measurement of Two-Photon Fluorescence Intensity and Enhancement Degree>

It is not easy to directly measure an amount of two-photon absorption in a sample, because fine particles which generate enhanced plasmon field absorb and scatter excitation light.

In this evaluation, a two-photon absorption dye, specifically, a fluorescent dye having two-photon absorbing ability was used as a dye, and an amount of fluorescence emitted by two-photon absorption was compared with that of Comparative Example to define an enhancement degree of two-photon absorption for measurement.

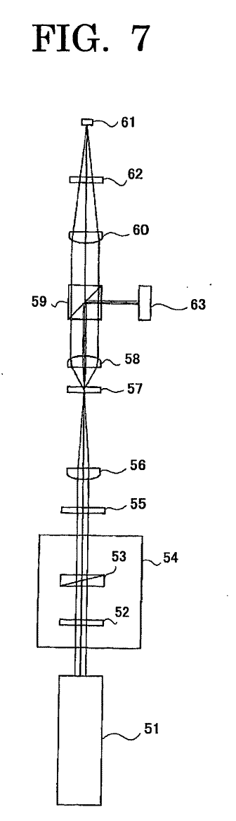

A measuring system of two-photon fluorescence is shown in FIG. 7.

An infrared femtosecond laser 51, MaiTai (from Spectra-Physics, Inc. a repetition frequency 80 MHz, and a pulse width 100 fs) was used as an excitation light.

The excitation light was passed through an attenuator 54 consisting of a ½λ plate 52 and a glan-laser prism 53 to control to have an average output of 200 mW and form circularly polarized light through a ¼λ plate 55, and then focused on a sample 57 using a plane-convex lens 56 having a focal length of 100 mm and collected fluorescence using a coupling lens 58 having a focal length of 40 mm so as to be substantially parallel light.

The excitation light was removed using a dichroic mirror 59, and then the light was condensed on a photodiode for detection 61 through a plane-convex lens 60 having a focal length of 100 mm.

An infrared cut glass filter 62 was placed in front of the photodiode for detection 61.

The excitation light removed by the dichroic mirror 59 was blocked by a beam block plate 63.

### <Evaluation Result>

In each sample of [Examples A-1 to A-5] and [Comparative Example A-1], the fluorescence of two-photon excitation was measured at a focus position of an excitation light source.

The amount of two-photon fluorescence of each sample of Examples A-1 to A-5 was compared with that of Comparative Example A-1 and the results of comparison of relative intensities are shown below.

[Comparative Example A-1] of the reference for relative comparison is omitted below.

<Result of Comparison of Relative Intensity of Two-Photon Fluorescence (Relative Amount of light)>

### Example 1

### 2.2

### Example 2

### 2.6

### Example 3

### 2.5

### Example 4

### 3.2

### Example 5

### 7.1

From the evaluation result, it is confirmed that the multiphoton absorption functional material of the present invention is a bulk material, in which the metal fine particles which generate enhanced surface plasmon field on the metal surface and the two-photon absorption material (two-photon absorption fluorescent dye) are dispersed, can largely enhance two-photon fluorescence, compared with Comparative Example where the conventional bulk material is used in which only two-photon absorption fluorescent dye is dispersed.

Additionally, enhancement effect can be further obtained by dispersing the aggregates in the bulk.

### <Second Evaluation: Evaluation of Bulk Sample and Laminated Sample>

An evaluation of a bulk sample and a laminated sample will be explained.

The bulk sample and laminated sample were evaluated in such a manner that three-dimensional recording and reading were performed by using the characteristic of a two-photon absorption reaction that reaction occurs only near the focal point of an excitation light, and then recording power threshold was evaluated.

The recording power threshold was evaluated by controlling a shutter of recording source 33, and writing a plurality of bits with changing an exposure time.

After recording, the recording surface was observed with a confocal microscope, and a photochromic effect of diarylethene as a recording material was evaluated based on the occurrence of reflectance change.

### <Evaluation Result>

As the multiphoton absorption functional material, the sensitivity of the gold nanorod- and photochromic dye-dispersed acrylic resin of [Example A-6] was compared with the sensitivity of conventional bulk body of photochromic dye dispersed acrylic resin of [Comparative Example A-2].

A recording power threshold of writing in a depth of approximately 50 μm from a surface and a recording power threshold of writing in a depth of approximately 450 μm from the surface were relatively compared.

A reference of the comparison was set to a recording power threshold in a depth of approximately 50 μm from the surface in [Comparative Example A-2].

### <Results of Relative Evaluations of Recording Power Threshold>

50 μm-depth from the surface

### Example A-6

### 0.53

### Comparative Example A-2

### 1.00

450 μm-depth from the surface

### Example A-6

### 0.68

### Comparative Example A-2

### 1.02

As is clear from the above evaluation results, the recording power thresholds in the depths of 50 μm and 450 μm from the surface of the sample of Example A-6 are decreased respectively, compared with those of Comparative Example A-2. Specifically, the sample of Example A-6 has a higher sensitivity than that of Comparative Example A-2.

Additionally, it is verified that the effect of absorption and scatter by one-photon can be avoided.

### <Third Evaluation>

As the multiphoton absorption functional material, the sensitivity of the gold nanorods- and photochromic dye-dispersed acrylic resin, in which the gold nanorods are dispersed at different concentrations, of [Example A-7] was compared with the sensitivity of the bulk body of gold nanorods- and photochromic dye-dispersed acrylic resin, in which the gold nanorods are uniformly dispersed, of [Comparative Example A-3].

The recording power threshold of writing in the surface side layer of the dye-containing layer and a recording power threshold of writing in the deepest layer of the fifth dye-containing layer were relatively compared for evaluation.

### <Result of Relative Evaluation of Recording Power Threshold>

First layer (surface side)

### Example A-7

### 0.99

### Comparative Example A-3

### 1.00

Fifth layer (undermost layer)

### Example A-7

### 1.05

### Comparative Example A-3

### 1.51

In the evaluation results, in Comparative Example A-3, the relatively-larger recording power is needed as the recording layer is located deeper, specifically, the sensitivity is outstandingly decreased as the recording layer is located deeper, but in Example A-7, the one-photon absorption amount is controlled in each layer, and the decrease of the sensitivity is effectively suppressed, and sensitivities do not greatly differ between the surface side layer and the lowermost layer. That is, it becomes clear that nonuniformity of the sensitivity in each layer can be suppressed by changing the concentration of the fine particles.

The above Examples are specific examples of the embodiments of the present invention, and other known compositions of materials may be added accordingly, which does not depart from the scope of the invention.

### Example B-1

Ten grams of silver nitrate and 37.1 g of oleylamine (85%) were added in 300 ml of toluene and stirred for 1 hour. Then, 15.6 g of ascorbic acid was added and stirred for 3 hours. Subsequently, 300 ml of acetone was added and a supernatant was removed by decantation and a solvent contained in a precipitate was distilled off to obtain spherical silver fine particles having a diameter of 10 nm to 30 nm.

The obtained spherical silver fine particles were redispersed in tetrahydrofuran, and coated on a 1 mm-thick glass substrate to form a silver fine particle layer having a thickness of 20 nm to 60 nm by spin coating.

A residual solvent was removed in an oven at 60° C., and then cooled to room temperature.

On the silver fine particle layer, a solution of the two-photon absorption dye represented by Formula (2) dissolved in 2,2,3,3-tetrafluoro-1-propanol was coated to form a layer having a thickness of 100 nm by spin coating so as to obtain a laminated sample.

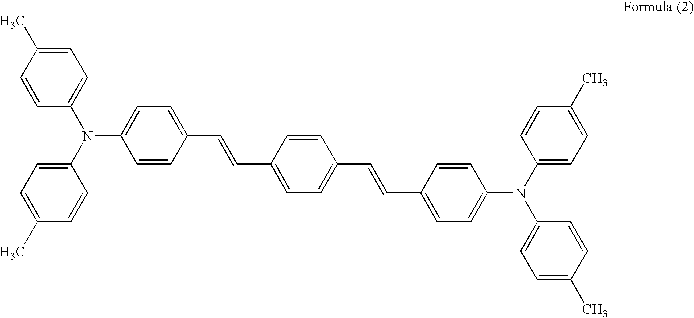

### Example B-2

Chloroauric acid (0.37 g) was added in 30 ml of water, and then a mixed solution of 2.187 g of tetraoctylammonium bromide in 80 ml of toluene was added and stirred for 2 hours.

Additionally, 0.2 g of 1-dodecanethiol was added and stirred for 1 hour.

Subsequently, a solution of 0.378 g of NaBH₄ dissolved in 20 ml of water was added dropwise and stirred for 2 hours.

The reaction product was washed with water using a separating funnel for several times, and then a solvent in an organic layer was distilled away to obtain spherical gold fine particles having a diameter of 20 nm to 50 nm.

The obtained spherical gold fine particles were redispersed in tetrahydrofuran, and coated on a 1 mm-thick glass substrate to form a gold fine particle layer having a thickness of 40 nm to 100 nm by spin coating. A residual solvent was removed in an oven at 60° C., and then cooled to room temperature.

On the gold fine particle layer, a solution of the two-photon absorption dye represented by Formula (2) dissolved in 2,2,3,3-tetrafluoro-1-propanol was coated to form a layer having a thickness of 100 nm by spin coating so as to obtain a laminated sample.

### Example B-3

Seventy milliliters aqueous solution of 0.18 mol/l cetyltrimethylammonium bromide, 0.36 ml of cyclohexane, 1 ml of acetone, and 1.3 ml aqueous solution of 0.1 mol/l silver nitrate were mixed and stirred. Subsequently, 0.3 ml aqueous solution of 0.24 mol/l chloroauric acid was added, and 0.3 ml aqueous solution of 0.1 mol/l ascorbic acid was further added so as to erase the color of the chloroauric acid solution, and the color erase was confirmed. This solution was poured into a dish and irradiated with an ultraviolet ray having a wavelength of 254 nm for 20 minutes using a low-pressure mercury lamp to obtain a gold nanorod dispersion having an absorption wavelength of approximately 830 nm. In the gold nanorod dispersion, the gold nanorod component was settled by centrifugation. The process of removing a supernatant from the dispersion, adding water and then centrifuging the dispersion was repeated several times to remove excess cetyltrimethylammonium bromide as a dispersant. The obtained gold nanorod dispersion was dropped on a 1 mm-thick glass substrate and dried naturally to obtain a gold nanorod layer having a thickness of 40 nm to 80 nm. On the gold fine particle (nanorod) layer, a solution of the two-photon absorption dye represented by Formula (2) dissolved in 2,2,3,3-tetrafluoro-1-propanol was coated to form a layer having a thickness of 100 nm by spin coating so as to obtain a laminated sample.

### Example B-4

Ethanol solution (5%) of (3-aminopropyl) ethyldiethoxysilane was coated on a 1 mm-thick glass substrate by spin coating, and then heated at 80° C. for 2 hours so as to subject the surface of the glass to silane coupling treatment.

The treated surface of the glass was immersed in the dispersion of silver fine particles in tetrahydrofuran obtained in Example B-1 and then pulled out.

A residual solvent was removed in an oven at 60° C. to obtain a fine particle layer, in which the silver fine particles were two-dimensionally placed on the surface of the glass in the form of substantially individual particle.

AMF observation confirmed that fine particles were present in a mix of two states: particles that are uniformly placed as individual particles, and those that are locally aggregated.

On the silver fine particle layer, a solution of the two-photon absorption dye represented by Formula (2) dissolved in 2,2,3,3-tetrafluoro-1-propanol was coated to form a layer having a thickness of 100 nm by spin coating so as to obtain a laminated sample.

### Example B-5

A surface of a glass substrate subjected to the silane coupling treatment in the same manner as in Example B-4 was immersed in the gold nanorod dispersion obtained in Example B-3 and then pulled out. A residual solvent was removed in an oven at 60° C. to obtain a fine particle layer, in which gold nanorod particles were two-dimensionally placed on the surface of the glass in the form of substantially individual particle.

AMF observation confirmed that fine particles were present in a mix of two states: particles that are uniformly placed as individual particles, and those that are locally aggregated.

On the gold nanorod layer, a solution of the two-photon absorption dye represented by Formula (2) dissolved in 2,2,3,3-tetrafluoro-1-propanol was coated to form a layer having a thickness of 100 nm by spin coating so as to obtain a laminated sample.

### Example B-6

One gram of the gold nanorod dispersion obtained in Example B-4 was mixed with 0.4 g of 1 mass % polyethylenimine, and then 2 g of DMF solution containing 5 mass % copolymer of polymethyl methacrylate and polymethacrylic acid was mixed, and concentrated to a several ml by decompression. The concentrated solution was dropped on a 1 mm-thick glass substrate, and the solvent was dried in an oven at 90° C. to obtain a layer having a thickness of 250 nm, in which gold nanorods were dispersed in a polymer. On the gold-nanorod-dispersed polymer layer, a solution of the two-photon absorption dye represented by Formula (2) dissolved in 2,2,3,3-tetrafluoro-1-propanol was coated to form a layer having a thickness of 100 nm by spin coating so as to obtain a laminated sample.

### Examples B-7 to B-12

Samples were prepared in the same manner as in Example B-1 except that the two-photon absorption dyes used in Examples B-1 to B-6 were changed to a dye compound represented by Formula (3).

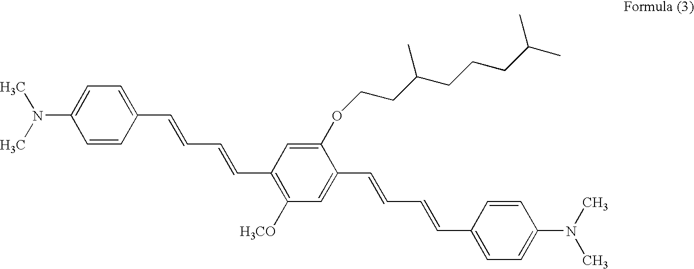

### Comparative Example B-1

A solution of the dye represented by Formula (2) dissolved in 2,2,3,3-tetrafluoro-1-propanol was coated to form a layer having a thickness of 100 nm on a 1 mm-thick glass substrate by spin coating so as to obtain a sample.

### Comparative Example B-2

A solution of the dye represented by Formula (3) dissolved in 2,2,3,3-tetrafluoro-1-propanol was coated to form a layer having a thickness of 100 nm on a 1 mm-thick glass substrate by spin coating so as to obtain a sample.

### <Evaluation of Amount of Two-Photon Absorption Fluorescence>

A schematic configuration diagram of measuring system is shown in FIG. 7.

It is not easy to directly measure the amount of two-photon absorption in each sample prepared as described above, because fine particles which generate enhanced plasmon field absorb and scatter excitation light.

A two-photon absorption material having fluorescent emission was used, and the amount of fluorescence emitted from each sample by two-photon absorption was relatively compared so as to measure an enhancement degree of two-photon absorption.

An infrared femtosecond laser MaiTai (from Spectra-Physics, Inc., a repetition frequency 80 MHz, a pulse width 100 fs, a measuring wavelength 780 nm, and an average irradiation power 50 mW) was used as an excitation light.

The excitation light was passed through an attenuator consisting of a ½λ plate and a glan-laser prism to control an output and form circularly polarized light through a ¼λ plate, and then focused on a sample using a plane-convex lens having a focal length of 100 mm and collected fluorescence using a coupling lens having a focal length of 40 mm so as to be substantially parallel light.

The excitation light was removed using a dichroic mirror, and then the light was collected on a photodiode for detection through a plane-convex lens having a focal length of 100 mm. An infrared cut glass filter was placed in front of the photodiode.

The fluorescence intensity was evaluated in such a manner that the fluorescence intensity of the sample of two-photon dye of Comparative Example B-1 or comparative Example B-2 was defined 1 as a reference value, and then fluorescence intensity of each Example is shown as a relative value to the reference value.

Evaluations by relative comparisons of Examples B-1 to B-6 with Comparative Example B-1 are shown in Table 1, and Examples B-7 to B-12 with Comparative Example B-2 are shown in Table 2.

TABLE 1

| | fluorescence intensity |
|---|---|
| Sample | (relative value) |
| Example B-1 | 3.2 |
| Example B-2 | 3.4 |
| Example B-3 | 4.6 |
| Example B-4 | 5.4 |
| Example B-5 | 6.7 |
| Example B-6 | 1.8 |
| Comparative Example B-1 | 1.0 |

TABLE 2

| | fluorescence intensity |
|---|---|
| Sample | (relative value) |
| Example B-7 | 3.1 |
| Example B-8 | 3.6 |
| Example B-9 | 4.8 |
| Example B-10 | 5.7 |
| Example B-11 | 6.6 |
| Example B-12 | 1.7 |
| Comparative Example B-2 | 1.0 |

As is clear from the evaluation results of Tables 1 and 2, due to the composite layer of the present invention, specifically, the composite layer in which the metal fine particle-containing layer and the multi(two) photon absorption material-containing layer are laminated, the multi(two) photon absorption functional material of the present invention can obtain enhancement of the photon absorption property effectively compared to the known multi(two) photon absorption functional material. Moreover, the metal fine particle-containing layer having larger area which contacts with the two photon absorption material-containing layer is expected to improve sensitization efficiency, compared to the metal fine particle-containing layer which is formed by dispersing the metal fine particles in a polymer. Furthermore, the aggregate of the metal fine particles which contact the two photon absorption material-containing layer allows to obtain further enhancement effect.

Hereinafter, specific samples of the mixture (multiphoton absorbing organic material) of the present invention were prepared and evaluated for their two-photon fluorescence intensity and enhancement degree.

### Example C-1

Chloroauric acid (0.37 g) was added in 30 ml of water, and then a mixed solution of 2.187 g of tetraoctylammonium bromide and 80 ml of toluene was added and stirred for 2 hours.

Additionally, 0.25 g of octadecanethiol was added and stirred for 1 hour.

Subsequently, a solution of 0.378 g of NaBH₄ dissolved in 20 ml of water was added dropwise and stirred for 2 hours.

The reaction product was washed with water using a separating funnel for several times, and then a solvent of an organic layer was distilled away to obtain spherical gold fine particles having a diameter of 20 nm to 50 nm.

Three milligrams of the obtained spherical gold fine particles were redispersed in 10 ml of toluene, and then 7 mg of the two-photon absorbing organic material represented by Formula (2) was added and stirred.

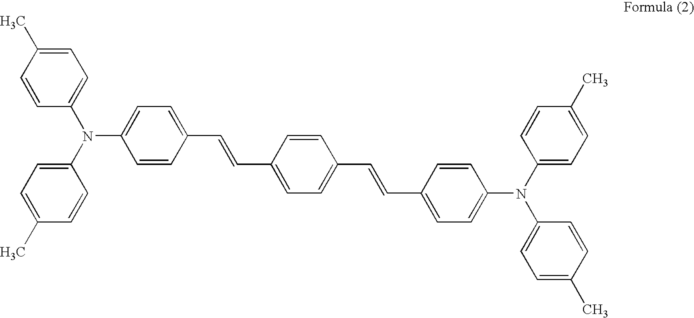

After stirring, 1 g of acrylic resin DIANAL BR-75 (from MITSUBISHI RAYON CO., LTD.) was further added and stirred to be melted. The obtained solution was poured in a frame formed on a glass substrate (casting). The solvent was vaporized for solidification, thereby yielded a bulk body consisting of the acrylic resin, spherical gold fine particles and two-photon absorbing organic material and dispersant (octadecanethiol), and having a thickness of 50 nm.

### Example C-2

Three milligrams of the spherical gold fine particles obtained in Example C-1 were redispersed in 10 ml of toluene, and then 7 mg of the two-photon absorbing organic material represented by Formula (2) was added and stirred. After stirring, the obtained solution was coated by spin coating on a glass substrate to form a 200 nm-thick layer consisting of the spherical gold fine particles, the two-photon absorbing organic material, and the dispersant (octadecanethiol).

### Example C-3

Chloroauric acid (0.37 g) was added in 30 ml of water, and then a mixed solution of 2.187 g of tetraoctylammonium bromide and 80 ml of toluene were added and stirred for 2 hours. Additionally, 0.025 g of octadecanethiol was added and stirred for 1 hour.

Subsequently, a solution of 0.378 g of NaBH₄ dissolved in 20 ml of water was added dropwise and stirred for 2 hours.

The reaction product was washed with water using a separating funnel for several times, and then the solvent of the organic layer was distilled away to obtain spherical gold fine particles having a diameter of 20 nm to 50 nm.

Three milligrams of the obtained spherical gold fine particles were redispersed in 10 ml of toluene, and then 7 mg of the two-photon absorbing organic material represented by Formula (2) was added and stirred. After stirring, the obtained solution was coated by spin coating on a glass substrate to form a 200 nm-thick layer consisting of the spherical gold fine particles, the two-photon absorbing organic material, and the dispersant (octadecanethiol) partly coating the spherical gold fine particles.

### Example C-4

Seventy milliliters aqueous solution of 0.18 mol/l cetyltrimethylammonium bromide, 0.36 ml of cyclohexane, 1 ml of acetone, and 1.3 ml aqueous solution of 0.1 mol/l silver nitrate were mixed and stirred. Subsequently, 0.3 ml aqueous solution of 0.24 mol/l chloroauric acid was added, and 0.3 ml aqueous solution of 0.1 mol/l ascorbic acid was further added so as to erase the color of the chloroauric acid solution, and the color erase was confirmed. This solution was poured into a dish and irradiated with an ultraviolet ray having a wavelength of 254 nm for 20 minutes using a low-pressure mercury lamp to obtain a gold nanorod dispersion having an absorption peak of approximately 830 nm. In this dispersion, a gold nanorod component was settled by centrifugation. The process of removing the supernatant from the dispersion, adding water and then centrifuging the dispersion was repeated several times to remove excess cetyltrimethylammonium bromide adsorbed on the gold nanorods as a dispersant. The thus prepared gold nanorod dispersion was stirred with 0.1 ml of 1% (3-aminopropyl) ethyldiethoxysilane in toluene solution, and 10 ml of toluene was further added and stirred so as to disperse the gold nanorods in a toluene layer. Subsequently, the solution was subjected to decantation to obtain gold nanorods coated with (3-aminopropyl) ethyldiethoxysilane dispersed in toluene solution. In 1 ml of the solution, 7 mg of a two-photon absorbing organic material represented by Formula (2) was added and stirred. After stirring, the obtained solution was coated by spin coating on a glass substrate to form a 200 nm-thick layer consisting of the gold nanorods, the two-photon absorbing organic material, and the dispersant (Si coupling agent: (3-aminopropyl) ethyldiethoxysilane).

### Example C-5

The gold nanorod dispersion obtained in Example C-4 was mixed and stirred with 0.1 ml of 1% 3-mercaptopropyl triethoxysilane in toluene solution, and 10 ml of a toluene was further added so as to disperse gold nanorods in a toluene layer. Subsequently, the solution was subjected to decantation to obtain a gold nanorods coated with 3-mercaptopropyl triethoxysilane dispersed in toluene solution.

In 1 ml of the solution, 7 mg of a two-photon absorbing organic material represented by the Formula (2) was added and stirred. After stirring, the obtained solution was coated by spin coating on a glass substrate to form a 200 nm-thick layer consisting of the gold nanorods, the two-photon absorbing organic material, and the dispersant (Si coupling agent: 3-mercaptopropyl triethoxysilane).

### Example C-6

Chloroauric acid tetrahydrate (0.1 g) was dissolved in 950 ml of ultrapure water, and then heated to boil. While the solution was stirred, 1% of sodium citrate aqueous solution was added thereto, heated to reflux, and then left standing to cool down to room temperature, thereby obtaining a solution containing spherical gold fine particles. In 100 ml of the obtained solution containing spherical gold fine particles, 0.1 ml of 1% 3-mercaptopropyl trimethoxysilane in acetone solution was added and stirred, and then in 1 ml of the solution, 7 mg of a two-photon absorbing organic material represented by Formula (2) was further added and stirred. After stirring, the obtained solution was coated by spin coating on a glass substrate to form a 200 nm-thick layer consisting of the spherical gold nanorods, the two-photon absorbing organic material, and the dispersant (Si coupling agent: 3-mercaptopropyl trimethoxysilane).

### Example C-7

Chloroauric acid tetrahydrate (0.1 g) was dissolved in 950 ml of ultrapure water, and then heated to boil. While the solution was stirred, 1% of sodium citrate aqueous solution was added thereto, heated to reflux, and then left standing to cool down to room temperature, thereby obtaining a solution containing spherical gold fine particles. In 100 ml of the obtained solution containing spherical gold fine particles, 1 ml of 1% 3-mercaptopropyl triethoxysilane in acetone solution was added and stirred, and then in 1 ml of the solution, 7 mg of a two-photon absorbing organic material represented by Formula (2) was further added and stirred. After stirring, the obtained solution was coated by spin coating on a glass substrate to form a 200 nm-thick layer consisting of the spherical gold nanorods, the two-photon absorbing organic material, and the dispersant (Si coupling agent: 3-mercaptopropyl triethoxysilane).

### Comparative Example C-1

Seven milligrams of a two-photon absorbing organic material represented by Formula (2) were added and stirred in 10 ml of toluene. After stirring, 1 g of acrylic resin DIANAL BR-75 (from MITSUBISHI RAYON CO., LTD.) was further added and stirred to be melted. The obtained solution was poured in a frame formed on a glass substrate (casting). The solvent was vaporized for solidification, thereby yielded a bulk body containing the acrylic resin, and having a thickness of 50 μm.

### Comparative Example C-2

Seven milligrams of a two-photon absorbing organic material represented by Formula (2) were added and stirred in 10 ml of toluene. The obtained solution was coated on a glass substrate to form a 200 nm-thick layer by spin coating.

### <Measurement of Two-Photon Fluorescence Intensity and Enhancement Degree>

It is not easy to directly measure the efficiency of two-photon absorption in a sample, due to incident light absorption and scattering affected by the metal fine particles.

In this respect, a material having fluorescent property was particularly exemplified as the sample of the two-photon absorbing organic material prepared in each of Examples and Comparative Examples, and the amount of fluorescence emitted by two-photon absorption was evaluated as an alternative measure of the efficiency of the two-photon absorption.

A schematic diagram of a measuring system of fluorescence amount is shown in FIG. 7.

An infrared femtosecond laser, MaiTai (from Spectra-Physics, Inc., a repetition frequency 80 MHz, and a pulse width 100 fs) was used as an excitation light for two-photon absorption.

The excitation light was passed through an attenuator consisting of a ½λ plate and a glan-laser prism to control to have an average output of 200 mW and form circularly polarized light through a ¼λ plate, and then focused on a sample using a plane-convex lens having a focal length of 100 mm, and fluorescence generated in a focal point of the excitation light was collected using a coupling lens having a focal length of 40 mm so as to be substantially parallel light. The excitation light was removed using a dichroic mirror, passed through an infrared cut glass filter, and condensed on a photodiode for detection through a plane-convex lens having a focal length of 100 mm.

### <Evaluation Result>

The amount of fluorescence of two-photon in each of Examples C-1 to C-7 was evaluated in comparison with that in each of Comparative Examples C-1 to C-2. The relative value between Example C-1 and Comparative Example C-1 is shown in Table 3, while the relative values between Examples C-2 to C-7 and Comparative Example C-2 are shown in Table 4.

TABLE 3
Relative Intensity of Amount of Fluorescence

| | Relative value to |
|---|---|
| Sample | Comparative Example C-1 |
| Example C-1 | 3.6 |

TABLE 4
Relative Intensity of Amount of Fluorescence

| | Relative value to |
|---|---|
| Sample | Comparative Example C-2 |
| Example C-2 | 5.5 |
| Example C-3 | 4.1 |
| Example C-4 | 8.8 |
| Example C-5 | 8.5 |
| Example C-6 | 6.2 |
| Example C-7 | 7.4 |

As shown in evaluation results in Tables 3 and 4, according to the invention, the efficiency of the multi-photon absorption of the multiphoton absorbing organic material can be significantly improved by using the localized enhanced plasmon field generated in the metal fine particles.

These Examples only exemplify an embodiment of the present invention and are not intended to change the scope of the invention, and other known materials can be also used.

1. A multiphoton absorption functional material comprising one of:
fine particles of metal, and
fine particles partly coated with the metal, the metal generating enhanced surface plasmon field on a metal surface,
wherein the fine particles or the fine particles partly coated with the metal are dispersed in a multiphoton absorption material, and
wherein the multiphoton absorption functional material is a bulk body.

2. The multiphoton absorption functional material according to claim 1, wherein the multiphoton absorption functional material is formed in at least a layer.

3. The multiphoton absorption functional material according to claim 2, wherein the multiphoton absorption functional material is formed in at least two layers, and the layers are separated by an intermediate layer which does not have multiphoton absorption ability.

4. The multiphoton absorption functional material according to claim 2, wherein each of the at least two layers formed from the multiphoton absorption functional material has substantially the same sensitivity of multiphoton absorption.

5. The multiphoton absorption functional material according to claim 2, wherein the concentration of the fine particles of metal or the fine particles partly coated with the metal, which metal generates enhanced surface plasmon field, is individually set in each of the at least two layers formed from the multiphoton absorption functional material.

6. The multiphoton absorption functional material according to claim 1, wherein the fine particles of metal or the fine particles partly coated with the metal are gold nanorods.

7. The multiphoton absorption functional material according to claim 1, wherein the fine particles of metal or the fine particles partly coated with the metal are aggregated nanoparticles.

8. A composite layer comprising:
a metal fine particle-containing layer comprising fine particles of metal which generates enhanced surface plasmon field on a metal surface, and
a multiphoton absorption material-containing layer comprising a multiphoton absorption material,
wherein the metal fine particle-containing layer and the multiphoton absorption material-containing layer are laminated.

9. The composite layer according to claim 8, wherein the fine particles in the metal fine particle-containing layer aggregate in a boundary between the metal fine particle-containing layer and the multiphoton absorption material-containing layer.

10. The composite layer according to claim 8, wherein the fine particles are gold nanorods.

11. The composite layer according to claim 8, wherein the composite layer is a multilayer comprising a plurality of laminated bodies which comprise the metal fine particle-containing layer and the multiphoton absorption material-containing layer, and each of the plurality of multiphoton absorption material layers has substantially the same sensitivity of multiphoton absorption.

12. A mixture comprising:
a multiphoton absorbing organic material,
fine particles of metal which generates localized enhanced plasmon field, and a dispersant.

13. The mixture according to claim 12, wherein the dispersant comprises a function of suppressing electron movement between the multiphoton absorbing organic material and the fine particles.

14. The mixture according to claim 12, wherein a surface of the fine particles is coated entirely or partly with the dispersant.

15. The mixture according to claim 12, wherein the dispersant is a silane coupling agent.

16. The mixture according to claim 12, wherein the mixture is solid at room temperature.

17. The mixture according to claim 12, wherein the fine particles are nanorods.

18-28. (canceled)
